(19) United States
(12) Patent Application Publication
(10) Pub. No.: US 2026/0151739 A1
(43) Pub. Date: Jun. 4, 2026

(54) WATER PURIFICATION DEVICE, FLUSHING CONTROL METHOD FOR WATER PURIFICATION DEVICE, AND WATER PURIFICATION SYSTEM

(71) Applicant: GREE ELECTRIC APPLIANCES, INC. OF ZHUHAI, Zhuhai, Guangdong (CN)

(72) Inventors: Wubin XIE, Zhuhai, Guangdong (CN); Yunzheng LONG, Zhuhai, Guangdong (CN); Jinbin LI, Zhuhai, Guangdong (CN); Yongsheng FANG, Zhuhai, Guangdong (CN); Qing DONG, Zhuhai, Guangdong (CN)

(21) Appl. No.: 18/696,592

(22) PCT Filed: Oct. 10, 2022
(86) PCT No.: PCT/CN2022/124328

§ 371 Date: Mar. 28, 2024

(30) Foreign Application Priority Data
Oct. 29, 2021 (CN) 202111272056.9
Oct. 29, 2021 (CN) 202122639413.2
Jan. 10, 2022 (CN) 202210022223.2

(51) Int. Cl. B01D 65/02; B01D 61/14; B01D 61/18; B01D 61/22; C02F 1/00; C02F 1/44; F16K 11/074

(52) U.S. Cl. CPC B01D 65/02; B01D 61/145; B01D 61/18; B01D 61/22; C02F 1/008; C02F 1/444; F16K 11/074; B01D 2313/12; B01D 2313/18; B01D 2313/701; B01D 2313/903; B01D 2317/04; B01D 2321/04; B01D 2321/12; C02F 2209/001; C02F 2209/006; C02F 2209/03; C02F 2209/44; C02F 2303/16

(57) ABSTRACT

A water purification device, a flushing control method for a water purification device, and a water purification system. The water purification device includes an ultrafiltration composite filter element and an opening/closing unit. The ultrafiltration composite filter element is provided with a plurality of filter elements connected in parallel. The opening/closing unit communicates with the water inlets of the plurality of filter elements. The opening/closing unit, when in a water-producing state, is configured to introduce raw water into the filter elements from the water inlets. The opening/closing unit, when in a flushing state, is further configured to introduce the raw water into the filter element(s) from the water inlet(s) of one or more filter elements; and the other one or more filter elements are flushed with the purified water, and then waste water is discharged by the water inlet(s) of the other one or more filter elements or a drainage outlet.

### CROSS-REFERENCE TO RELATED APPLICATION

The disclosure claims priority to Chinese Patent Application No. 202111272056.9 filed on Oct. 29, 2021 and entitled “Water Purification Device, Flushing Control Method for Water Purification Device, and Water Purification System”, Chinese Patent Application No. 202122639413.2 filed on Oct. 29, 2021 and entitled “Water Purification Device”, and Chinese Patent Application No. 202210022223.2 filed on Jan. 10, 2022 and entitled “Water Purification Device, Flushing Control Method for Water Purification Device, and Water Purification System”, the disclosures of which are hereby incorporated by reference in their entirety.

### TECHNICAL FIELD

The present disclosure relates to the technical field of water purifiers, and specifically to a water purification device, a flushing control method for a water purification device, and a water purification system.

### BACKGROUND

With the improvement of the living quality of people, the use of water purifiers is gradually popularized. In order to guarantee the quality of purified water of a water purifier, a filter element in the water purifier needs to be washed after being used for a long time. A common washing mode includes manual disassembly washing and automatic washing. The manual disassembly washing method is complicated in operation, and causes a lot of inconvenience to users. The traditional automatic washing technology usually uses raw water to perform forward and backward flushing on the filter element, but more clogged situations will occur while washing is performed at places where water quality is poor. If automatic flushing is performed with the purified water, a water storage tank needs to be disposed, and the flushing of the filter element needs to be realized through cooperation of a plurality of electric valves.

### SUMMARY

A water purification device provided by the present disclosure includes an ultrafiltration composite filter element and an opening/closing unit. The ultrafiltration composite filter element is provided with a plurality of filter elements connected in parallel. Each of the plurality of filter elements is provided with at least one water inlet and at least one purified water outlet. The purified water outlets of the plurality of filter elements communicate with each other. The opening/closing unit communicates with the water inlets of the plurality of filter elements. The opening/closing unit, when in a water-producing state, is configured to introduce raw water into the filter elements from the water inlets, and discharge purified water by the purified water outlets after filtration of the filter elements. The opening/closing unit is further configured to switch from the water-producing state to a flushing state, and, when in the flushing state, introduce the raw water into the filter element(s) from water inlet(s) of one or more filter elements in the plurality of filter elements. In this case, the purified water outlets of the plurality of filter elements are closed and communicate with each other, an other one or more filter elements in the plurality of filter elements are flushed with the purified water, and then waste water is discharged by the water inlet(s) of the other one or more filter elements.

In some embodiments, the ultrafiltration composite filter element includes a first filter element and a second filter element, which are disposed in parallel; and the flushing state of the opening/closing unit includes a first filter element backward flushing second filter element state and a second filter element backward flushing first filter element state.

In some embodiments, the water purification device includes a raw water inlet and a waste water outlet. When the opening/closing unit is in the water-producing state, the opening/closing unit is configured to simultaneously communicate the raw water inlet with a water inlet of the first filter element and a water inlet of the second filter element. When the opening/closing unit is in the first filter element backward flushing second filter element state, the opening/closing unit is configured to communicate the raw water inlet with the water inlet of the first filter element, and communicate the waste water outlet with the water inlet of the second filter element. When the opening/closing unit is in the second filter element backward flushing first filter element state, the opening/closing unit is configured to communicate the raw water inlet with the water inlet of the second filter element, and communicate the waste water outlet with the water inlet of the first filter element.

In some embodiments, the first filter element is provided with a first ultrafiltration membrane, and provided with a first water inlet and a first purified water outlet; the first water inlet communicates with an inner side or an outer side of the first ultrafiltration membrane, and the first purified water outlet communicates with the outer side or the inner side of the first ultrafiltration membrane. The first water inlet and the first purified water outlet respectively communicate with different sides of the inner side and the outer side of the first ultrafiltration membrane.

In some embodiments, the second filter element is provided with a second ultrafiltration membrane, and provided with a second water inlet and a second purified water outlet; the second water inlet communicates with an inner side or an outer side of the second ultrafiltration membrane, and the second purified water outlet communicates with the outer side or the inner side of the second ultrafiltration membrane. The second water inlet and the second purified water outlet respectively communicate with different sides of the inner side and the outer side of the second ultrafiltration membrane.

In some embodiments, when the opening/closing unit is in the water-producing state, the raw water inlet communicates with the first water inlet and the second water inlet, such that the raw water flows through the first ultrafiltration membrane or the second ultrafiltration membrane and then is discharged by the first purified water outlet and the second purified water outlet.

In some embodiments, when the opening/closing unit is in the first filter element backward flushing second filter element state, the raw water inlet communicates with the first water inlet such that the raw water flows through the first ultrafiltration membrane, then is discharged by the first purified water outlet, enters from the second purified water outlet, and then is discharged by the second water inlet after flowing through the second ultrafiltration membrane.

In some embodiments, when the opening/closing unit is in the second filter element backward flushing first filter element state, the raw water inlet communicates with the second water inlet such that the raw water flows through the second ultrafiltration membrane, then is discharged by the second purified water outlet, enters from the first purified water outlet, and then is discharged by the first water inlet after flowing through the first ultrafiltration membrane.

In some embodiments, the ultrafiltration composite filter element further includes a filter element base body, which is configured to communicate with the ultrafiltration composite filter element; the filter element base body (a6) is provided with N channels, where N=M, and M is a sum of a number of the water inlets and the purified water outlets.

In some embodiments, the first filter element and the second filter element are disposed at upper and lower parts or inner and outer layers.

In some embodiments, the opening/closing unit includes an integrated valve, and the integrated valve includes a valve body, a valve core, and a rotary disc. The valve body is provided with a valve body inlet, at least three cavities, and at least three outlets, respectively; the at least three cavities include a first valve body cavity, a second valve body cavity, and a third valve body cavity; and the at least three outlets include a first outlet, a second outlet, and a third outlet. The valve core is disposed on an upper end surface of the valve body and provided with a valve core inlet and at least three valve core outlets; a first valve core outlet of the valve core communicates with the first valve body cavity; a second valve core outlet of the valve core communicates with the second valve body cavity; a third valve core outlet of the valve core communicates with the third valve body cavity of the valve body; and the valve core inlet communicates with the valve body inlet. The rotary disc is provided with a plurality of flow paths, respectively; through rotation of the rotary disc, a corresponding flow path in the plurality of flow paths communicates with a corresponding valve core inlet and a valve core outlet of the at least three valve core outlets, so as to switch each of the plurality of flow paths.

In some embodiments, the first valve body cavity, the second valve body cavity, and the third valve body cavity are spaced apart from each other. The first valve body cavity sequentially communicates with a first outlet/inlet pipeline and a first water inlet through the first outlet. The second valve body cavity sequentially communicates with a second outlet/inlet pipeline and a second water inlet through the second outlet. The third valve body cavity communicates with a waste water outlet through the third outlet. One of the first valve body cavity and the second valve body cavity is configured to selectively communicate with the third valve body cavity. At least one of the first valve body cavity and the second valve body cavity is configured to selectively communicate with the valve body inlet.

In some embodiments, the rotary disc includes a first flow path and a second flow path; when the integrated valve is in a first position, the first flow path and the second flow path are disposed in parallel and connected to an outside.

In some embodiments, the first flow path communicates with the valve core inlet and the first valve core outlet, and the second flow path communicates with the valve core inlet and the second valve core outlet.

In some embodiments, the rotary disc further includes a third flow path and a fourth flow path; the third flow path communicates with the valve core inlet and the first valve core outlet, and the fourth flow path communicates with the second valve core outlet and the third valve core outlet; or the third flow path communicates with the valve core inlet and the second valve core outlet, and the fourth flow path communicates with the first valve core outlet and the third valve core outlet.

In some embodiments, when the integrated valve is in the first position, the rotary disc rotates to the first position, the valve core inlet of the valve core communicates with the first valve core outlet through the first flow path of the rotary disc, and the valve core inlet communicates with the second valve core outlet through the second flow path; the first valve core outlet communicates with the first valve body cavity of the valve body, and then communicates with the first water inlet through the first outlet/inlet pipeline; the second valve core outlet communicates with the second valve body cavity of the valve body, and then communicates with the second water inlet through the second outlet/inlet pipeline.

In some embodiments, when the integrated valve is in a second position, the rotary disc rotates to the second position, the valve core inlet communicates with the first valve core outlet through the third flow path of the rotary disc, the second valve core outlet communicates with the third valve core outlet through the fourth flow path, and in this case, the first valve core outlet communicates with the first valve body cavity of the valve body, then communicates with the first filter element sequentially via the first outlet/inlet pipeline and the first water inlet, then communicates with the second valve body cavity via the second water inlet or the drainage outlet and the second outlet/inlet pipeline, and then communicates with the waste water outlet through the second valve core outlet via the fourth flow path of the rotary disc, the third valve core outlet, and the third valve body cavity of the valve body.

In some embodiments, when the integrated valve is in a third position, the rotary disc rotates to the third position, the valve core inlet communicates with the second valve core outlet through the third flow path of the rotary disc, the first valve core outlet communicates with the third valve core outlet through the fourth flow path, and in this case, the second valve core outlet communicates with the second valve body cavity of the valve body, then communicates with the second filter element sequentially via the second outlet/inlet pipeline and the second water inlet, then communicates with the first valve body cavity via the first water inlet or the drainage outlet and the first outlet/inlet pipeline, and then communicates with the waste water outlet through the first valve core outlet via the fourth flow path of the rotary disc, the third valve core outlet, and the third valve body cavity of the valve body.

In some embodiments, the fourth flow path is constructed as a kidney-shaped groove; and when the integrated valve is in a second position or a third position, the kidney-shaped groove rotates to communicate with two adjacent valve core outlets of the valve core.

In some embodiments, the drainage outlet includes a first drainage outlet and a second drainage outlet; the first drainage outlet communicates with the outer side or the inner side of the first ultrafiltration membrane; the second drainage outlet communicates with the outer side or the inner side of the second ultrafiltration membrane.

In some embodiments, in the water-producing state, the first drainage outlet and the second drainage outlet are closed at the same time; in the first filter element backward flushing second filter element state, the first drainage outlet is closed, and the second drainage outlet is selectively opened; and in the second filter element backward flushing first filter element state, the second drainage outlet is closed, and the first drainage outlet is selectively opened.

A flushing control method provided in the present disclosure includes the following operations. A fouling parameter is acquired.

Whether the fouling parameter reaches a fouling threshold is determined.

When the fouling parameter reaches the fouling threshold, an opening/closing unit is controlled to act according to a preset flushing policy.

In some embodiments, the fouling parameter includes a current water outlet flow value or a current water outlet pressure value.

In some embodiments, the method further includes: acquiring a current water inlet pressure value; and determining a flushing time Tₜₒₜₐₗ based on the current water inlet pressure value and a correspondence relationship between the current water inlet pressure value and a flushing time.

In some embodiments, the opening/closing unit includes an integrated valve; and the operation of when the fouling parameter reaches the fouling threshold, controlling the opening/closing unit to act according to the preset flushing policy includes the following operations.

An integrated valve action is adjusted to a first flushing state, and the first flushing state is stayed for a time Tₜₒₜₐₗ/2n.

The integrated valve action is adjusted to a second flushing state, and the second flushing state is stayed for the time Tₜₒₜₐₗ/2n.

Cycles of the first flushing state and the second flushing state are repeated for a total of n times.

The integrated valve action is adjusted to an initial state.

A flushing control apparatus provided in the present disclosure includes an acquisition module, a determination module, and a control module.

The acquisition module is configured to acquire a fouling parameter.

The determination module is configured to determine whether the fouling parameter reaches a fouling threshold.

The control module is configured to, when the fouling parameter reaches the fouling threshold, control an opening/closing unit to act according to a preset flushing policy.

In some embodiments, the acquisition module includes at least one of a flow detection module and a pressure detection module.

An electrical device provided in the present disclosure includes a processor and a memory.

The processor is configured to execute a flushing control program stored in the memory, so as to implement the flushing control method described above.

A storage medium provided in the present disclosure stores one or more programs; the one or more programs are executable by one or more processors, so as to implement the flushing control method described above.

The present disclosure further provides a water purification system, which includes the water purification device described above, a post-processing assembly, a water pump, a water inlet pipeline, and a purified water outlet pipeline. The water pump is disposed on a front end of the post-processing assembly. The water inlet pipeline communicates with a raw water inlet of the water purification device. The purified water outlet pipeline communicates with a purified water outlet of the water purification device. The water purification device is disposed on a front end of the water pump, a water inlet of the water pump communicates with the purified water outlet pipeline, and a water outlet of the water pump communicates with the post-processing assembly, so as to transport purified water filtered by the water purification device into the post-processing assembly.

According to the water purification device provided in some embodiments of the present disclosure, the ultrafiltration composite filter element provided with the plurality of filter elements connected in parallel is used, the opening/closing unit communicate with the water inlets of the plurality of filter elements, and the opening/closing unit can be switched between the water-producing state and the flushing state, such that complex connection pipelines and valves are not required, and the water purification device is simple in structure and convenient in operation; and in the flushing state, the purified water produced by one or more filter elements is used to flush other filter elements, such that a good purified water flushing effect is achieved, thereby improving user satisfaction.

According to the water purification device provided in some embodiments of the present disclosure, by disposing an inner housing to divide an internal space of an outer housing into a first filter element cavity and a second filter element cavity, the first filter element cavity is provided with the first filter element, and the second filter element cavity is provided with the second filter element, such that a parallel composite arrangement of two filter elements is realized, and an overall volume of the ultrafiltration composite filter element is effectively reduced. Simultaneously, the first filter element includes the first water inlet and the first purified water outlet, and the second filter element includes the second water inlet and the second purified water outlet, such that the ultrafiltration composite filter element is switched among a water-producing mode, a first filter element backward flushing second filter element mode, and a second filter element backward flushing first filter element mode according to conducting states of the water inlet and the water outlet; and the ultrafiltration composite filter element can be switched among different modes by only changing the conducting states of the water inlet and the water outlet, such that the water purification device is simple in structure, convenient in operation, and good in cleaning effect.

According to the water purification device provided in some embodiments of the present disclosure, by disposing the number of ring channels of the filter element base body to be equal to the total number of the water inlets and the water outlets, each ring channel corresponds to one water inlet or one water outlet, respectively, and each ring channel is provided with an opening communicating with an external pipeline, such that the water inlet and the water outlet communicate with the external pipeline, so as to conveniently control the conducting states of the water inlet and the water outlet, thus realizing the switching of the ultrafiltration composite filter element between the water-producing mode and the flushing mode.

According to the water purification device provided in some embodiments of the present disclosure, the filter element base body includes a main purified water port, the main purified water port communicates with the water outlet, and when the ultrafiltration composite filter element is in the water-producing mode, the purified water discharged by the first purified water outlet and the second purified water outlet is discharged to the external pipeline; and when the ultrafiltration composite filter element is in the flushing mode, the main purified water port is closed, and the purified water produced by the filter elements is unable to be discharged to the external pipeline, such that the purified water flows through a flow path in which the first purified water outlet communicates with the second purified water outlet, thereby achieving one filter element performing backward flushing on the other filter element.

According to the water purification device provided in some embodiments of the present disclosure, the valve body is provided with the valve body inlet, the first valve body cavity, the second valve body cavity, the first outlet/inlet pipeline, the second outlet/inlet pipeline, and the third outlet; simultaneously, the valve core is provided with the valve core inlet and at least three valve core outlets, the first valve core outlet of the valve core communicates with the first valve body cavity, the second valve core outlet of the valve core communicates with the second valve body cavity, the third valve core outlet communicates with the third valve body cavity, and the valve core inlet communicates with the valve core inlet; and simultaneously, the rotary disc is provided with the plurality of flow paths, respectively, and through the rotation of the rotary disc, the corresponding flow path communicates with the corresponding valve core inlet and the valve core outlet, so as to switch each of the flow paths. It can be seen that, by adding the integrated valve, a situation of simultaneously using a plurality of valves can be saved, such that the water purification device has the advantages of being small in volume, low in cost, and high in integration.

According to the flushing control method provided in some embodiments of the present disclosure, whether to execute a flushing operation is determined by determining whether the fouling parameter reaches the fouling threshold, and when the fouling parameter reaches the fouling threshold, controlling the integrated valve to act according to the preset flushing policy, the water purification device is accurately controlled; and compared with a traditional control method for flushing by depending on preset time, situations that severe blockage due to different clogging caused by different water qualities in different regions cannot be flushed timely or resources are wasted as flushing is performed before the clogging needs to be flushed are solved, such that user experience is improved.

### BRIEF DESCRIPTION OF THE DRAWINGS

In order to more clearly illustrate the embodiments of the present disclosure or the technical solutions in traditional technologies, the drawings used in the description of the embodiments or the traditional technologies will be briefly described below. It is apparent that the drawings in the following descriptions are merely the embodiments of the present disclosure. Other drawings can be obtained from those skilled in the art according to the disclosed drawings without any creative work.

FIG. 1 illustrates a cross-sectional view of a composite filter element provided with filter elements at upper and lower parts according to the present disclosure.

FIG. 2 illustrates a schematic diagram of a composite filter element provided with filter elements at upper and lower parts in a water-producing state according to the present disclosure.

FIG. 3 illustrates a schematic diagram of a composite filter element provided with filter elements at upper and lower parts in a first filter element backward flushing second filter element state according to the present disclosure.

FIG. 4 illustrates a schematic diagram of a composite filter element provided with upper and lower filter elements in a second filter element backward flushing first filter element state according to the present disclosure.

FIG. 5 illustrates a cross-sectional view of a composite filter element provided with filter elements at inner and outer layers according to the present disclosure.

FIG. 6 illustrates a schematic diagram of an explode state of an integrated waterway plate and an integrated valve according to the present disclosure.

FIG. 7 illustrates a schematic diagram of an integrated waterway plate according to the present disclosure.

FIG. 8 illustrates a schematic cross-sectional view of a mounting state of an integrated waterway plate and an integrated valve according to the present disclosure.

FIG. 9 illustrates a top view of a mounting state of an integrated waterway plate and an integrated valve according to the present disclosure.

FIG. 10 illustrates a top view of an integrated waterway plate according to the present disclosure.

FIG. 11 illustrates a schematic structural diagram of a valve core according to the present disclosure.

FIG. 12 illustrates a schematic structural diagram of a rotary disc according to the present disclosure.

FIG. 13 illustrates a cross-sectional view of a partial section of an integrated waterway plate according to the present disclosure.

FIG. 14 illustrates a schematic diagram of an internal structure of an integrated valve in a first position according to the present disclosure.

FIG. 15 illustrates a schematic diagram of an internal structure of an integrated valve in a second position according to the present disclosure.

FIG. 16 illustrates a schematic diagram of an internal structure of an integrated valve in a third position according to the present disclosure.

FIG. 17 illustrates a schematic diagram of an explode state of a composite filter element, an integrated waterway plate, and an integrated valve according to the present disclosure.

FIG. 18 illustrates a schematic cross-sectional view of a mounting state of a composite filter element, an integrated waterway plate, and an integrated valve according to the present disclosure.

FIG. 19 illustrates a flowchart of a flushing control method according to the present disclosure.

FIG. 20 illustrates a principle block diagram of a flushing control apparatus according to the present disclosure.

FIG. 21 illustrates a schematic structural diagram of an electrical device according to the present disclosure.

FIG. 22 illustrates a schematic structural diagram of a water purification system according to the present disclosure.

FIG. 23 illustrates a schematic deformation diagram of a composite filter element provided with filter elements at upper and lower parts according to the present disclosure.

In the drawings:
a1, Composite filter element; a11, First ultrafiltration membrane; a12, Second ultrafiltration membrane; a2, Outer housing; a3, Inner housing; a41, First water inlet; a42, Second water inlet, a51, First purified water outlet; a52, Second purified water outlet; a6, Filter element base body; a61, First ring channel; a611, First ring channel opening; a62, Second ring channel; a621, Second ring channel opening; a63, Third ring channel; a631, Third ring channel opening; a64, Center circular channel; a641, Center circular channel opening; a65, Main purified water port; a91, First drainage outlet; a92, Second drainage outlet;
b0, Integrated valve; b1, Valve body; b11, Raw water inlet; b12, First valve body cavity; b13, Second valve body cavity; b14, First outlet/inlet pipeline; b15, Second outlet/inlet pipeline; b16, Waste water outlet; b17, Third valve body cavity; b2, Valve core; b21, Valve core inlet; b22, First valve core outlet; b23, Second valve core outlet; b3, Rotary disc; b31, First flow path; b32, Second flow path; b33, Third flow path; b34, Fixed hole; b35, Kidney-shaped groove; b4, Motor; b5, Press cover;
d4, Water inlet pipeline; d5, Purified water outlet pipeline; f3, Post-processing assembly; f31, Flowmeter; f32, Water pump; f321, Water pump control module; f33, Pre-processing unit; f34, Reverse osmosis filter element; f35, Reverse osmosis water outlet control valve; f36, Post-processing filter element; f37, Pressure switch; f38, Water faucet;
21, Acquisition module; 22, Determination module; 23, Control module;
400, Electrical device; 401, Processor; 402, Memory; 4021, Operating system; 4022, Application program; 403, User interface; 404, Network interface; 405, Bus system.

### DETAILED DESCRIPTION OF THE EMBODIMENTS

The technical solutions in the embodiments of the present disclosure will be clearly and completely described below in combination with the drawings in the embodiments of the present disclosure. It is apparent that the described embodiments are only part of the embodiments of the present disclosure, not all the embodiments. All other embodiments obtained by those of ordinary skill in the art on the basis of the embodiments in the present disclosure without creative work all fall within the scope of protection of the present disclosure.

In the description of this application, it is to be noted that, terms such as “center”, “up”, “down”, “left”, “right”, “vertical”, “horizontal”, “inside”, “outside”, and the like are orientation or position relationships shown in the drawings, are adopted not to indicate or imply that indicated apparatuses or components must be in specific orientations or structured and operated in specific orientations but only to conveniently describe this application and simplify descriptions, and thus should not be construed as limits to this application. In addition, the terms “first”, “second” and “third” are for descriptive purposes only, and should not be construed as indicating or implying relative importance.

In the description of this application, it is to be noted that, unless otherwise clearly specified and limited, the terms “mounted”, “connected” and “connect” should be interpreted broadly. For example, the term “connect” may be fixed connection, detachable connection or integral construction. As an alternative, the term “connect” may be mechanical connection, or electrical connection. As an alternative, the term “connect” may be direct connection, or indirect connection through a medium, or communication in two elements. For those of ordinary skill in the art, specific meanings of the above-mentioned terms in the present disclosure may be understood according to a specific condition.

In addition, the technical features involved in the different implementations of the present disclosure described below may be combined with each other so long as they do not conflict with each other.

### Embodiment I

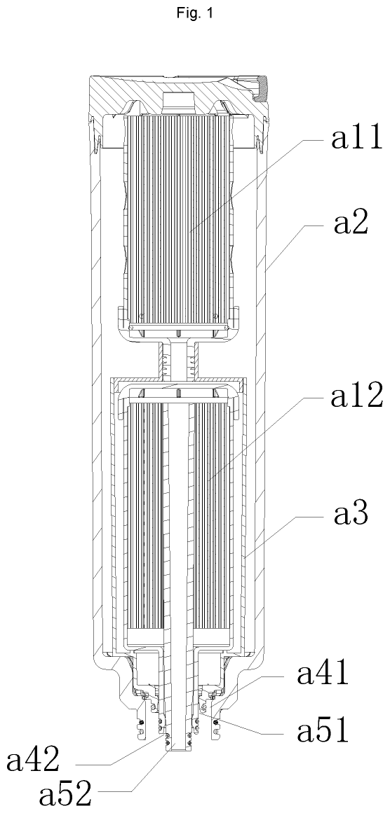

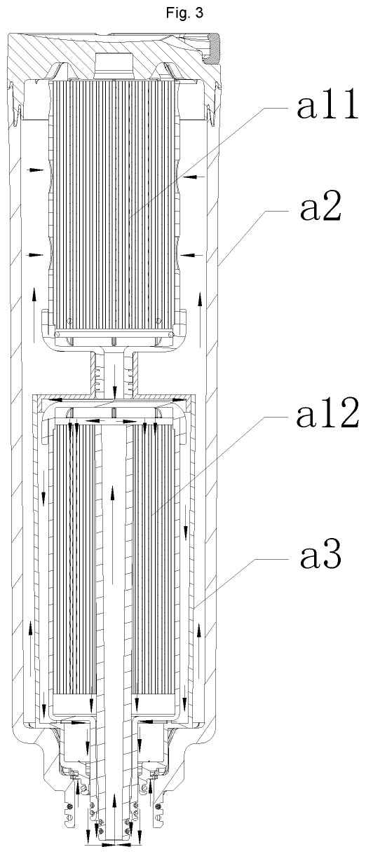

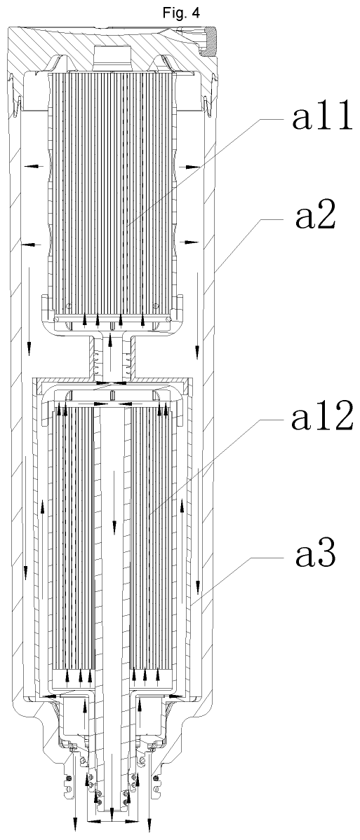

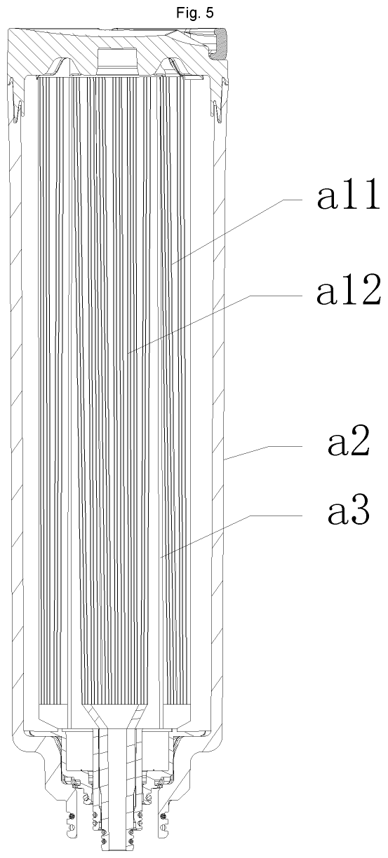

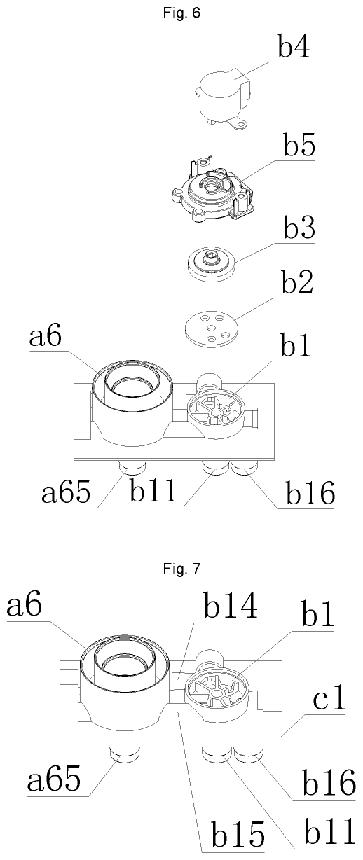

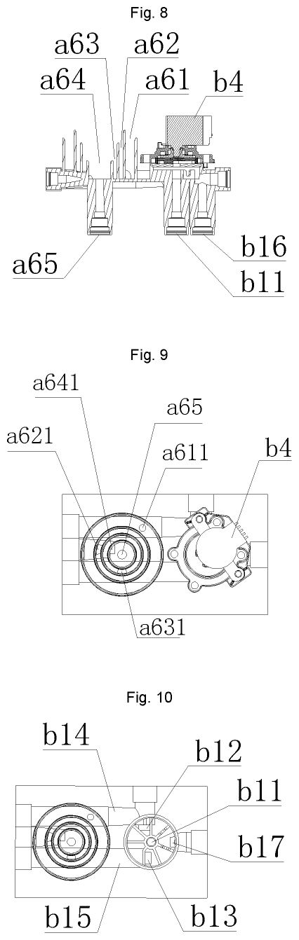

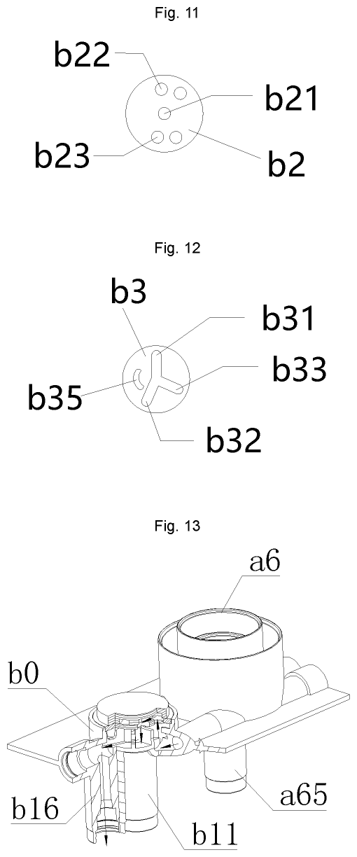

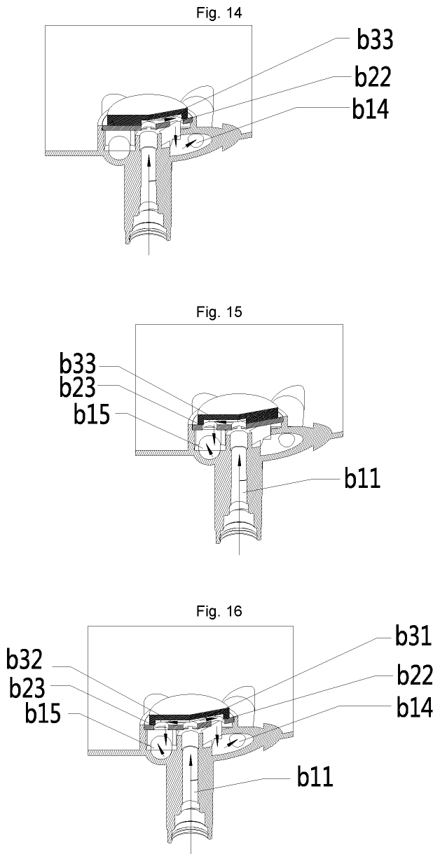

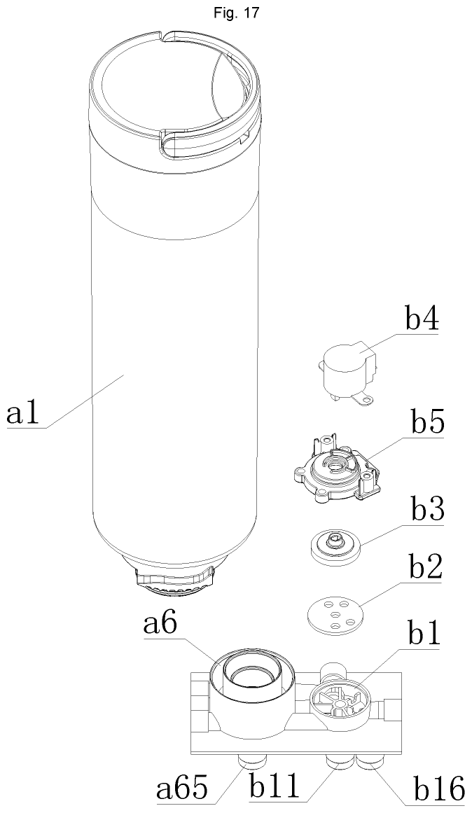

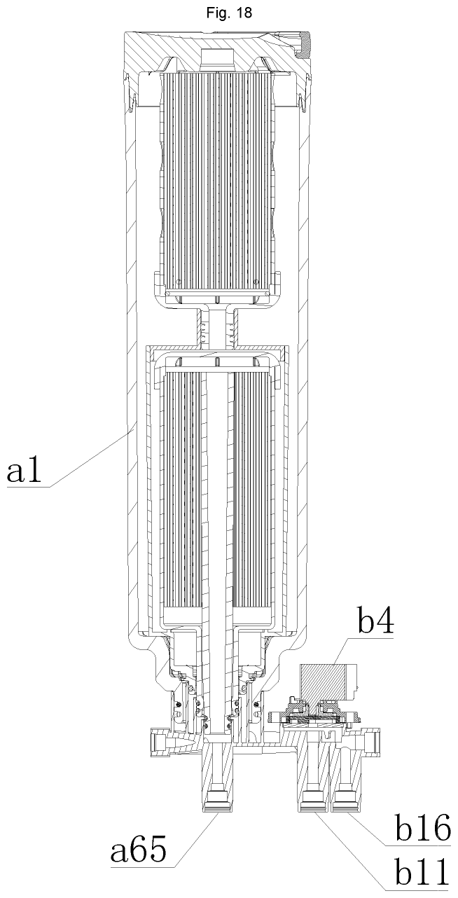

In combination with FIG. 1 to FIG. 18, A water purification device provided in some embodiments includes an ultrafiltration composite filter element a1 and an opening/closing unit. The ultrafiltration composite filter element a1 is provided with a plurality of filter elements connected in parallel; each of the plurality of filter elements is provided with at least one water inlet and at least one purified water outlet; and the purified water outlets of the plurality of filter elements communicate with each other. The opening/closing unit communicates with the water inlets of the plurality of filter elements. The opening/closing unit, when in a water-producing state, is configured to introduce raw water into the filter elements from the water inlets, and discharge purified water by the purified water outlets after filtration of the filter elements. The opening/closing unit is further configured to switch from the water-producing state to a flushing state, and, when in the flushing state, introduce the raw water into the filter element(s) from the water inlet(s) of one or more filter elements in the plurality of filter elements; and in this case, the purified water outlets of the plurality of filter elements are closed and communicate with each other, the other one or more filter elements in the plurality of filter elements are flushed with the purified water, and then waste water is discharged by the water inlet(s) of the other one or more filter elements.

The opening/closing unit can be in various forms of a valve assembly, an integrated valve, a pipeline clamp, etc.; and the opening/closing unit is configured to control an opening/closing state of a water inlet pipeline and/or a water outlet pipeline. In some embodiments, descriptions are performed by using the opening/closing unit being the integrated valve as examples.

The raw water refers to the water that is not filtered by the ultrafiltration composite filter element, and the purified water is obtained through filtration of the filter element of the water purification device; and the waste water refers to the water that is obtained by cleaning the filter element of the water purification device.

When the opening/closing unit is in a water-producing state, the raw water is introduced into the filter elements from the water inlets, and the purified water is discharged by the purified water outlets after filtration of the filter elements.

When the opening/closing unit is in a flushing state, the raw water is introduced into the filter element(s) from the water inlet(s) of one or more filter elements, and the purified water is produced after the filtration of the filter elements; and in this case, the purified water outlets of the plurality of filter elements are closed and communicate with each other, such that the purified water is unable to be discharged and then flows into the other one or more filter elements along a pathway, so as to cause the purified water to flush the other one or more filter elements, and then the waste water is discharged by the water inlet(s) of the other one or more filter elements.

When the opening/closing unit is in the flushing state, that the purified water outlets of the plurality of filter elements are closed and communicate with each other means that the purified water outlets of the filter elements are all in a closed state, such that the purified water is unable to be discharged while the purified water outlets between the filter elements communicate with each other, and the purified water conveniently flows from one filter element to another filter element, so as to realize backward flushing of the purified water on the filter elements.

The ultrafiltration composite filter element a1 is provided with the plurality of filter elements connected in parallel, and the plurality of filter elements mean that there can be two or more filter elements. When there are two or more filter elements, the filter elements can be arranged in parallel.

According to the water purification device provided in some embodiments, the ultrafiltration composite filter element provided with the plurality of filter elements connected in parallel is used, the opening/closing unit communicate with the water inlets of the plurality of filter elements, and the opening/closing unit can be switched between the water-producing state and the flushing state, such that complex connection pipelines and valves are not required, and the water purification device is simple in structure and convenient in operation; and in the flushing state, the purified water produced by one or more filter elements is used to flush other filter elements, such that a good purified water flushing effect is achieved, thereby improving user satisfaction.

In some embodiments, the ultrafiltration composite filter element a1 includes a first filter element and a second filter element, which are disposed in parallel; and the flushing state of the opening/closing unit includes a first filter element backward flushing second filter element state and a second filter element backward flushing first filter element state.

In some embodiments, the water purification device includes a raw water inlet b11 and a waste water outlet b16.

When the opening/closing unit is in the water-producing state, the opening/closing unit is configured to simultaneously communicate the raw water inlet b11 with the water inlet of the first filter element and the water inlet of the second filter element.

When the opening/closing unit is in the first filter element backward flushing second filter element state, the opening/closing unit is configured to communicate the raw water inlet b11 with the water inlet of the first filter element, and communicate the waste water outlet b16 with the water inlet of the second filter element.

When the opening/closing unit is in the second filter element backward flushing first filter element state, the opening/closing unit is configured to communicate the raw water inlet b11 with the water inlet of the second filter element, and communicate the waste water outlet b16 with the water inlet of the first filter element.

In some embodiments, the ultrafiltration composite filter element a1 includes an outer housing a2, an inner housing a3, the first filter element, and the second filter element. The inner housing a3 is disposed in the outer housing a2 in a nested manner; and the inner housing a3 is configured to divide an internal space of the outer housing a2 into a first filter element cavity and a second filter element cavity. The first filter element is disposed in the first filter element cavity. The second filter element is disposed in the second filter element cavity. The first filter element and the second filter element are respectively provided with the water inlets suitable for the raw water to enter; the first filter element and the second filter element share or are respectively provided with the purified water outlets suitable for discharging of the purified water; and the first filter element and the second filter element are disposed in parallel.

In some embodiments, opening ends of the first filter element cavity and the second filter element cavity respectively communicate with an external pipeline.

In some embodiments, the ultrafiltration composite filter element is configured to switch among the water-producing state, the first filter element backward flushing second filter element state, and the second filter element backward flushing first filter element state according to conducting states of the water inlets and the purified water outlets.

One end of the ultrafiltration composite filter element is provided with an opening, and communicates with the external pipeline; and the external pipeline refers to a pipeline supply or discharge water for the ultrafiltration composite filter element. The water-producing state means that the first filter element and the second filter element are both in a working state in which the raw water is introduced into the water inlet, and the purified water is discharged by the water outlet after the raw water is filtered by an ultrafiltration membrane. The first filter element backward flushing second filter element state refers to a working state in which only the first filter element produces the purified water, and the produced purified water is used to flush an ultrafiltration membrane of the second filter element. The second filter element backward flushing first filter element state refers to a working state in which only the second filter element produces the purified water, and the produced purified water is used to flush an ultrafiltration membrane of the first filter element. An outer side of the ultrafiltration membrane refers to a side of the ultrafiltration membrane close to the outer housing, and an inner side of the ultrafiltration membrane refers to a side of the ultrafiltration membrane opposite to the outer side.

In the ultrafiltration composite filter element provided in some embodiments, through the arrangement, the inner housing a3 is configured to divide the internal space of the outer housing a2 into the first filter element cavity and the second filter element cavity. The first filter element is disposed in the first filter element cavity, and the second filter element is disposed in the second filter element cavity, such that a parallel composite arrangement of two filter elements is realized, and an overall volume of the ultrafiltration composite filter element is effectively reduced. The first filter element and the second filter element are respectively provided with the water inlets suitable for the raw water to enter, and the first filter element and the second filter element share or are respectively provided with the purified water outlets suitable for discharging of the purified water, such that the ultrafiltration composite filter element is switched among the water-producing state, the first filter element backward flushing second filter element state, and the second filter element backward flushing first filter element state according to the conducting states of the water inlets and the purified water outlets. The ultrafiltration composite filter element can be switched among the three states by only changing the conducting states of the water inlet and the water outlet, such that a simple structure, a convenient operation, and a good cleaning effect are achieved, thereby improving user satisfaction.

In some embodiments, the first filter element is provided with a first ultrafiltration membrane a11, and provided with a first water inlet a41 and a first purified water outlet a51; the first water inlet a41 communicates with an inner side or an outer side of the first ultrafiltration membrane a11, and the first purified water outlet a51 communicates with the outer side or the inner side of the first ultrafiltration membrane a11. The first water inlet a41 and the first purified water outlet a51 respectively communicate with different sides of the inner side and the outer side of the first ultrafiltration membrane a11.

The second filter element is provided with a second ultrafiltration membrane a12, and provided with a second water inlet a42 and a second purified water outlet a52; the second water inlet a42 communicates with an inner side or an outer side of the second ultrafiltration membrane a12, and the second purified water outlet a52 communicates with the outer side or the inner side of the second ultrafiltration membrane a12. The second water inlet a42 and the second purified water outlet a52 respectively communicate with different sides of the inner side and the outer side of the second ultrafiltration membrane a12.

In some embodiments, the first purified water outlet a51 and the second purified water outlet a52 are independently disposed on the outer housing a2, or the first purified water outlet a51 and the second purified water outlet a52 converge in the ultrafiltration composite filter element, and jointly communicate with one purified water outlet provided on the outer housing a2.

In some embodiments, the outer side of the first ultrafiltration membrane a11 is provided with a first protective layer; the first protective layer is provided with a plurality of through holes; and the through holes are configured to communicate the first ultrafiltration membrane a11 with the first filter element cavity.

In some embodiments, the outer side of the second ultrafiltration membrane a12 is provided with a second protective layer; a spacing layer is formed between the second protective layer and the inner housing a3; and the first filter element communicates with the first purified water outlet a51 through the spacing layer.

In some embodiments, water-producing modes of the first ultrafiltration membrane a11 and the second ultrafiltration membrane a12 are external pressure modes.

In some embodiments, a position arrangement implementation of the first water inlet a41, the first purified water outlet a51, the second water inlet a42, and the second purified water outlet a52 is implemented as a sequential arrangement from outside to inside. For example, the first water inlet a41 is sleeved outside the first purified water outlet a51, the first purified water outlet a51 is sleeved outside the second water inlet a42, and the second water inlet a42 is sleeved outside the second purified water outlet a52.

When the opening/closing unit is in the water-producing state, the raw water inlet b11 communicates with the first water inlet a41 and the second water inlet a42, such that the raw water flows through the first ultrafiltration membrane a11 or the second ultrafiltration membrane a12 and then is discharged by the first purified water outlet a51 and the second purified water outlet a52.

When the opening/closing unit is in the first filter element backward flushing second filter element state, the raw water inlet b11 communicates with the first water inlet a41 such that the raw water flows through the first ultrafiltration membrane a11, then is discharged by the first purified water outlet a51, enters from the second purified water outlet a52, and then is discharged by the second water inlet a42 after flowing through the second ultrafiltration membrane a12.

When the opening/closing unit is in the second filter element backward flushing first filter element state, the raw water inlet b11 communicates with the second water inlet a42 such that the raw water flows through the second ultrafiltration membrane a12, then is discharged by the second purified water outlet a52, enters from the first purified water outlet a51, and then is discharged by the first water inlet a41 after flowing through the first ultrafiltration membrane a11.

In some embodiments, when the composite filter element a1 is in the water-producing mode, the first water inlet a41 and the second water inlet a42 are water inlets, the first purified water outlet a51 and the second purified water outlet a52 are water outlets, and the first water inlet a41 communicates with the first filter element cavity and communicates with the first purified water outlet a51 after passing through the first ultrafiltration membrane a11; and the second water inlet a42 communicates with the second filter element cavity, and communicates with the second purified water outlet a52 after passing through the second ultrafiltration membrane a12.

When the ultrafiltration composite filter element a1 is in the first filter element backward flushing second filter element mode, the first water inlet a41 and the second purified water outlet a52 are the water inlets, the first purified water outlet a51 and the second water inlet a42 are the water outlets, and the first water inlet a41 communicates with the first filter element cavity, sequentially communicates with the first purified water outlet a51 and the second purified water outlet a52 after passing through the first ultrafiltration membrane a11, and then communicates with the second water inlet a42 after passing through the second ultrafiltration membrane a12.

When the ultrafiltration composite filter element a1 is in the second filter element backward flushing first filter element mode, the first purified water outlet a51 and the second water inlet a42 are the water inlets, the first water inlet a41 and the second purified water outlet a52 are the water outlets, and the second water inlet a42 communicates with the second filter element cavity, sequentially communicates with the second purified water outlet a52 and the first purified water outlet a51 after passing through the second ultrafiltration membrane a12, and then communicates with the first water inlet a41 after passing through the first ultrafiltration membrane a11.

According to the water purification device provided in some embodiments, by disposing the inner housing a3 to divide the internal space of the outer housing a2 into the first filter element cavity and the second filter element cavity, the first filter element cavity is provided with the first filter element, and the second filter element cavity is provided with the second filter element, such that a parallel composite arrangement of two filter elements is realized, and an overall volume of the ultrafiltration composite filter element is effectively reduced. Simultaneously, the first filter element includes the first water inlet a41 and the first purified water outlet a51, and the second filter element includes the second water inlet a42 and the second purified water outlet a52, such that the ultrafiltration composite filter element is switched among the water-producing state, the first filter element backward flushing second filter element mode, and the second filter element backward flushing first filter element mode according to conducting states of the water inlet and the water outlet; and the ultrafiltration composite filter element can be switched among different modes by only changing the conducting states of the water inlet and the water outlet, such that the water purification device is simple in structure, convenient in operation, and good in cleaning effect.

In some embodiments, the ultrafiltration composite filter element a1 further includes a filter element base body a6, which is configured to communicate with the ultrafiltration composite filter element a1. The filter element base body (a6) is provided with N channels, where N=M, and M is a sum of the number of the water inlets and the purified water outlets. In some embodiments, the first purified water outlet a51 and the second purified water outlet a52 are two independent outlets, and respectively communicate with the external pipeline. The filter element base body a6 includes a first ring channel a61, a second ring channel a62, a third ring channel a63, and a center circular channel a64. The first ring channel a61 communicates with the first water inlet a41; and the first ring channel a61 is provided with a first ring channel opening a611, which is configured to communicate the first water inlet a41 with the external pipeline. The second ring channel a62 communicates with the first purified water outlet a51; and the second ring channel a62 is provided with a second ring channel opening a621, which is configured to communicate the first purified water outlet a51 with the external pipeline. The third ring channel a63 communicates with the second water inlet a42; and the third ring channel a63 is provided with a third ring channel opening a631, which is configured to communicate the second water inlet a42 with the external pipeline. The center circular channel a64 communicates with the second purified water outlet a52; the center circular channel a64 is provided with a center circular channel opening a641, which is configured to communicate the second purified water outlet a52 with the external pipeline; and the center circular channel opening a641 communicates with the second ring channel opening a621. In some embodiments, the first ring channel a61 is sleeved outside the second ring channel a62, the second ring channel a62 is sleeved outside the third ring channel a63, and the third ring channel a63 is sleeved outside the center circular channel a64.

In some embodiments, the ultrafiltration composite filter element a1 includes at least two filter elements; and when there are three filter elements, the filter element base body a6 includes 5 ring channels and one center circular channel.

In some embodiments, the first purified water outlet a51 and the second purified water outlet a52 communicate in the ultrafiltration composite filter element a1 and are converged to a converging outlet, and the converging outlet communicates with the external pipeline, such that the filter element base body a6 includes the first ring channel a61, the third ring channel a63, and the center circular channel a64. The first ring channel a61 communicates with the first water inlet a41; and the first ring channel a61 is provided with a first ring channel opening a611, which is configured to communicate the first water inlet a41 with the external pipeline. The third ring channel a63 communicates with the second water inlet a42; and the third ring channel a63 is provided with a third ring channel opening a631, which is configured to communicate the second water inlet a42 with the external pipeline. The center circular channel a64 communicates with the converging outlet; the center circular channel a64 is provided with the center circular channel opening a641, which is configured to communicate the converging outlet with the external pipeline.

In some embodiments, when there are three filter elements, the filter element base body a6 includes 3 ring channels and one center circular channel.

In some embodiments, the ring channels and center circular channel of the filter element base body a6 are mated with the water inlet and the water outlet in a sealing manner by means of sealing rings.

According to the water purification device provided in some embodiments, by disposing the number of ring channels of the filter element base body a6 to be equal to the total number of the water inlets and the water outlets, each ring channel corresponds to one water inlet or one water outlet, respectively, and each ring channel is provided with an opening communicating with an external pipeline, such that the water inlet and the water outlet communicate with the external pipeline, so as to conveniently control the conducting states of the water inlet and the water outlet, thus realizing the switching of the ultrafiltration composite filter element between the water-producing mode and the flushing mode.

When the first purified water outlet a51 and the second purified water outlet a52 are two independent outlets, the total number of the water inlets and purified water outlets is 4, and in this case, the filter element base body a6 is provided with 4 channels in total, which are the first ring channel a61, the second ring channel a62, the third ring channel a63, and the center circular channel a64.

When the first purified water outlet a51 and the second purified water outlet a52 communicate in the ultrafiltration composite filter element and are converged to the converging outlet, the total number of the water inlets and purified water outlets is 3, and in this case, the filter element base body a6 is provided with 3 channels in total, which are the first ring channel a61, the third ring channel a63, and the center circular channel a64.

In some embodiments, the filter element base body a6 further includes a main purified water port a65. The main purified water port a65 communicates with the first purified water outlet a51 and the second purified water outlet a52 through the center circular channel opening a641.

In some embodiments, the water purification device further includes a first outlet/inlet pipeline b14 and a second outlet/inlet pipeline b15. The first outlet/inlet pipeline b14 is configured to communicate the first ring channel a61 with the integrated valve b0; and the second outlet/inlet pipeline b15 is configured to communicate the third ring channel a63 with the integrated valve b0.

In some embodiments, the first filter element and the second filter element are disposed at upper and lower parts or inner and outer layers.

In some embodiments, the opening/closing unit includes the integrated valve b0, and the integrated valve b0 includes a valve body b1, a valve core b2, and a rotary disc b3.

The valve body b1 is provided with a valve body inlet, at least three cavities, and at least three outlets. The at least three cavities include a first valve body cavity b12, a second valve body cavity b13, and a third valve body cavity b17. The at least three outlets include a first outlet, a second outlet, and a third outlet.

The valve core b2 is disposed on an upper end surface of the valve body b1. The valve core is provided with a valve core inlet b21 and at least three valve core outlets, which include a first valve core outlet b22, a second valve core outlet b23, and a third valve core outlet. The first valve core outlet b22 communicates with the first valve body cavity b12; the second valve core outlet b23 communicates with the second valve body cavity b13; the third valve core outlet communicates with the third valve body cavity b17 of the valve body b1; and the valve core inlet b21 communicates with the valve body inlet.

The rotary disc b3 is provided with a plurality of flow paths, respectively; through rotation of the rotary disc b3, the corresponding flow path in the plurality of flow paths communicates with the corresponding valve core inlet b21 and a valve core outlet of the at least three valve core outlets, so as to switch each of the flow paths.

In some embodiments, the valve body inlet is configured to communicate with the raw water inlet b11.

In the water purification device provided in some embodiments, the valve body is provided with the valve body inlet, the first valve body cavity b12, the second valve body cavity b13, the first outlet/inlet pipeline b14, the second outlet/inlet pipeline b15, and the third outlet. The valve core b2 is provided with the valve core inlet b21 and the at least three valve core outlets. The first valve core outlet b22 communicates with the first valve body cavity b12; the second valve core outlet communicates with the second valve body cavity b13; the third valve core outlet communicates with the third valve body cavity b17 of the valve body; and the valve core inlet b21 communicates with the valve body inlet. The rotary disc b3 is provided with a plurality of flow paths, respectively; through rotation of the rotary disc b3, the corresponding flow path communicates with the corresponding valve core inlet b21 and the valve core outlet, so as to switch each of the flow paths. By adding the integrated valve b0, a situation of simultaneously using a plurality of valves can be saved, such that the advantages of being small in volume, low in cost, and high in integration are achieved.

In some embodiments, the first valve body cavity b12, the second valve body cavity b13, and the third valve body cavity b17 are spaced apart from each other. The first valve body cavity b12 communicates with the first outlet/inlet pipeline b14 through the first outlet. The second valve body cavity b13 communicates with the second outlet/inlet pipeline b15 through the second outlet. The third valve body cavity b17 communicates with the waste water outlet b16 through the third outlet. One of the first valve body cavity b12 and the second valve body cavity b13 is configured to selectively communicate with the third valve body cavity b17. At least one of the first valve body cavity b12 and the second valve body cavity b13 is configured to selectively communicate with the valve body inlet.

In some embodiments, the rotary disc b3 includes a first flow path b31 and a second flow path b32. When the integrated valve b0 is in a first position, the first flow path b31 and the second flow path b32 are disposed in parallel and connected to an outside.

When the integrated valve b0 is in the first position, an environment to which the integrated valve b0 is applied can be in the water-producing state; when the integrated valve b0 is in a second position, the environment to which the integrated valve b0 is applied is in the first filter element backward flushing second filter element mode; and when the integrated valve b0 is in a third position, the environment to which the integrated valve b0 is applied is in the second filter element backward flushing first filter element mode.

In some embodiments, the first flow path b31 communicates with the valve core inlet b21 and the first valve core outlet b22, and the second flow path b32 communicates with the valve core inlet b21 and the second valve core outlet b23.

In some embodiments, the rotary disc b3 further includes a third flow path b33 and a fourth flow path. The third flow path b33 communicates with the valve core inlet b21 and the first valve core outlet b22, and the fourth flow path communicates with the second valve core outlet b23 and the third valve core outlet; or the third flow path b33 communicates with the valve core inlet b21 and the second valve core outlet b23, and the fourth flow path communicates with the first valve core outlet b22 and the third valve core outlet.

In some embodiments, when the integrated valve b0 is in the first position, the rotary disc b3 rotates to the first position, the valve core inlet b21 of the valve core b2 communicates with the first valve core outlet b22 through the first flow path b31 of the rotary disc b3, and the valve core inlet b21 communicates with the second valve core outlet b23 through the second flow path b32; the first valve core outlet b22 communicates with the first valve body cavity b12 of the valve body b1, and then communicates with the first ring channel a61 through the first outlet/inlet pipeline b14; the second valve core outlet b23 communicates with the second valve body cavity b13 of the valve body b1, and then communicates with the third ring channel a63 through the second outlet/inlet pipeline b15.

When the integrated valve b0 is in the second position, the rotary disc b3 rotates to the second position, the valve core inlet b21 communicates with the first valve core outlet b22 through the third flow path b33 of the rotary disc b3, and the second valve core outlet b23 communicates with the third valve core outlet through the fourth flow path. In this case, the first valve core outlet b22 communicates with the first valve body cavity b12 of the valve body b1, then communicates with the first filter element sequentially via the first outlet/inlet pipeline b14 and the first ring channel a61, then communicates with the second valve body cavity b13 via the third ring channel a63 and the second outlet/inlet pipeline b15, and then communicates with the waste water outlet b16 through the second valve core outlet b23 via the fourth flow path of the rotary disc b3, the third valve core outlet, and the third valve body cavity b17 of the valve body b1.

When the integrated valve b0 is in the third position, the rotary disc b3 rotates to the third position, the valve core inlet b21 communicates with the second valve core outlet b23 through the third flow path b33 of the rotary disc b3, and the first valve core outlet b22 communicates with the third valve core outlet through the fourth flow path. In this case, the second valve core outlet b23 communicates with the second valve body cavity b13 of the valve body b1, then communicates with the second filter element sequentially via the second outlet/inlet pipeline b15 and the third ring channel a63, then communicates with the first valve body cavity b12 via the first ring channel a61 and the first outlet/inlet pipeline b14, and then communicates with the waste water outlet b16 through the first valve core outlet b22 via the fourth flow path of the rotary disc b3, the third valve core outlet, and the third valve body cavity b17 of the valve body.

In some embodiments, the fourth flow path is constructed as a kidney-shaped groove b35; and when the integrated valve b0 is in the second position or the third position, the kidney-shaped groove b35 rotates to communicate with two adjacent valve core outlets of the valve core b2.

In some embodiments, the valve core b2 can be provided with 5 ports, which include one water inlet, two water outlets, and two waste water outlets. And in some embodiments, the two waste water outlets can be combined into one.

In some embodiments, in combination with FIG. 23, the drainage outlet includes a first drainage outlet a91 and a second drainage outlet a92; when the first water inlet a41 communicates with the inner side or the outer side of the first ultrafiltration membrane a11, the first drainage outlet a91 communicates with the outer side or the inner side of the first ultrafiltration membrane a11; and when the second water inlet a42 communicates with the inner side or the outer side of the second ultrafiltration membrane a12, the second drainage outlet a92 communicates with the outer side or the inner side of the second ultrafiltration membrane a12.

In the water-producing state, the first drainage outlet a91 and the second drainage outlet a92 are closed at the same time.

In the first filter element backward flushing second filter element state, the first drainage outlet a91 is closed, and the second drainage outlet a92 is selectively opened.

In the second filter element backward flushing first filter element state, the second drainage outlet a92 is closed, and the first drainage outlet a91 is selectively opened.

In some embodiments, the first drainage outlet a91 penetrates through the outer housing a2; one end of the first drainage outlet a91 communicates with the first ultrafiltration membrane a11, and the other end of the first drainage outlet a91 communicates with the outside; the second drainage outlet a92 penetrates through the inner housing a3; and one end of the second drainage outlet a92 communicates with the second ultrafiltration membrane a12, and the other end of the second drainage outlet a92 communicates with the outside.

The first drainage outlet a91 is disposed, such that in the first filter element backward flushing second filter element state, the raw water inlet b11 communicates with the first water inlet a41 such that the raw water flows through the first ultrafiltration membrane a11, then is discharged by the first purified water outlet a51, enters from the second purified water outlet a52, and then is discharged by the first drainage outlet a91 after flowing through the second ultrafiltration membrane a12. In some embodiments, in this state, the first drainage outlet a91 and the second water inlet a42 can be simultaneously or alternatively conducted.

The second drainage outlet a92 is disposed, such that in the second filter element backward flushing first filter element state, the raw water inlet b11 communicates with the second water inlet a42 such that the raw water flows through the second ultrafiltration membrane a12, then is discharged by the second purified water outlet a52, enters from the first purified water outlet a51, and then is discharged by the second drainage outlet a92 after flowing through the first ultrafiltration membrane a11. In some embodiments, in this state, the second drainage outlet a92 and the first water inlet a41 can be simultaneously or alternatively conducted.

In some embodiments, the integrated valve b0 further includes a motor b4 and a pressure cover b5. The pressure cover b5 is disposed on the rotary disc b3; the rotary disc b3 is provided with a fixed hole b34 matching a motor shaft of the motor b4; the motor b4 is disposed on the pressure cover b5; the motor b4 is connected with the pressure cover b5 through a fastener; the pressure cover b5 is provided with a through hole; the motor shaft of the motor b4 can be inserted into the fixed hole b34 by passing through the through hole; and the motor shaft rotates to drive the rotary disc b3 to rotate.

In some embodiments, the motor b4 is added, and the motor shaft of the motor b4 is inserted into the fixed hole b34 on the rotary disc b3 after passing through the through hole on the pressure cover b5. It is to be noted that, the motor shaft is inserted into the fixed hole b34, and the motor shaft and the fixed hole b34 are in fixed connection in a circumferential direction, that is, through the rotation of the motor shaft, the rotary disc b3 can be driven to rotate to achieve the purpose of switching different flow paths.

The “fastener” can include a bolt, a screw, a rivet, or the like.

In some embodiments, the pressure cover b5 is fixedly connected with the valve body b1 through the fastener, so as to fix the rotary disc b3 and the valve core b2 between the pressure cover b5 and the valve body b1.

In some embodiments, the valve core b2 is disposed on the upper end surface of the valve body b1; the rotary disc b3 is disposed on an upper end surface of the valve core b2; the pressure cover b5 is disposed on an upper end surface of the rotary disc b3; the motor shaft of the motor b4 is inserted into the fixed hole b34 on the rotary disc b3 after passing through the through hole on the pressure cover b5; then the motor b4 is connected with the valve body b1 by using the fastener; and simultaneously, the motor b4 is connected with the pressure cover b5 by using the fastener. In this way, the fixed mounting of the entire integrated valve can be realized.

In some embodiments, the rotary disc b3 and the valve core b2 both are made of a hard material.

In some embodiments, the hard material includes ceramics.

In some embodiments, the rotary disc b3 can rotate relative to the valve core b2, so as to achieve the purpose of switching different flow paths; and due to the material, a function of mutual sealing between the rotary disc b3 and the valve core b2 can be realized.

In some embodiments, the integrated valve b0 further includes a sealing member disposed between the valve core b2 and the valve body b1; and the sealing member can seal each cavity of the valve core b2 and form the valve body b1 into an independent cavity so as to be connected with each valve core outlet of the valve core b2.

In some embodiments, the sealing member is a silicone gasket or a rubber gasket.

In some embodiments, the rotary disc b3 can rotate relative to the valve core b2, so as to switch different flow paths. It is to be noted that, the rotary disc b3 can be driven by the motor b4, and meanwhile, the rotary disc b3 can also be driven to rotate by means of manual rotation.

A working mode of the water purification device of the embodiments of the present disclosure is described in detail.

When the water purification device is in the water-producing mode, the waste water outlet b16 is closed, the integrated valve b0 is in the first position, and the raw water inlet b11 simultaneously communicates with the first valve body cavity b12 and the second valve body cavity b13 through the valve body inlet. The raw water is introduced from the raw water inlet b11, enters the first valve body cavity b12 by sequentially passing through the valve core inlet b21, the first flow path b31, and the first valve core outlet b22, then enters the first filter element cavity by passing through the first outlet/inlet pipeline b14, the first ring channel a61, and the first water inlet a41, and is filtered by the first ultrafiltration membrane a11, so as to obtain the purified water. The produced purified water arrives at the first purified water outlet a51 by flowing through the spacing layer between the second ultrafiltration membrane and the inner housing a3, communicates with the main purified water port a65 via the first purified water outlet a51 and the second ring channel a62, and is finally discharged by the main purified water port a65. Meanwhile, the raw water is introduced from the raw water inlet b11, enters the second valve body cavity b13 by sequentially passing through the valve core inlet b21, the second flow path b32, and the second valve core outlet b23, then enters the second filter element cavity by passing through the second outlet/inlet pipeline b15, the third ring channel a63, and the second water inlet a42, and is filtered by the second ultrafiltration membrane a12, so as to obtain the purified water. The produced purified water communicates with the main purified water port a65 via the first purified water outlet a51 and the center circular channel a64, and is finally discharged by the main purified water port a65.

When the water purification device is in the flushing mode, the main purified water port a65 is closed, and the waste water outlet b16 is opened. In the first filter element backward flushing second filter element mode, the integrated valve b0 is in the second position, the raw water inlet b11 communicates with the first valve body cavity b12 through the valve body inlet, and the second valve body cavity b13 communicates with the third valve body cavity b17. The raw water is introduced from the raw water inlet b11, enters the first filter element cavity by passing through the first valve body cavity b12, the first outlet/inlet pipeline b14, the first ring channel a61, and the first water inlet a41, and is filtered by the first ultrafiltration membrane a11, so as to obtain the purified water. The produced purified water enters the second filter element by passing through the first purified water outlet a51, the second ring channel a62, the center circular channel a64, and the second purified water outlet a52, flows through the second ultrafiltration membrane a12, and cleans the second ultrafiltration membrane a12. The waste water after cleaning sequentially passes through the second water inlet a42, the third ring channel a63, the second outlet/inlet pipeline b15, the second valve body cavity b13, and the third valve body cavity b17, and is then discharged by the waste water outlet b16. As a deformation, the waste water after cleaning can also be discharged by the second drainage outlet a92. In this case, a two-position three-way valve is disposed between the second water inlet a42 and the second drainage outlet a92; and by switching the conducting state of the valve, one of the second water inlet a42 and the second drainage outlet a92 is selected to be conducted, and then the waste water after cleaning is discharged through follow-up water paths.

In the second filter element backward flushing first filter element mode, the integrated valve b0 is in the third position, the raw water inlet b11 communicates with the second valve body cavity b13 through the valve body inlet, and the first valve body cavity b12 communicates with the third valve body cavity b17. The raw water is introduced from the raw water inlet b11, enters the second filter element cavity by sequentially passing through the second valve body cavity b13, the second outlet/inlet pipeline b15, the third ring channel a63, and the second water inlet a42, and is filtered by the second ultrafiltration membrane a12, so as to obtain the purified water. The produced purified water enters the first filter element by passing through the second purified water outlet a52, the center circular channel a64, the second ring channel a62, and the first purified water outlet a51, flows through the first ultrafiltration membrane a11, and cleans the first ultrafiltration membrane a11. The waste water after cleaning sequentially passes through the first water inlet a41, the first ring channel a61, the first outlet/inlet pipeline b14, the first valve body cavity b12, and the third valve body cavity b17, and is then discharged by the waste water outlet b16. As a deformation, the waste water after cleaning can also be discharged by the first drainage outlet a91. In this case, a two-position three-way valve is disposed between the first water inlet a41 and the first drainage outlet a91; and by switching the conducting state of the valve, one of the first water inlet a41 and the first drainage outlet a91 is selected to be conducted, and then the waste water after cleaning is discharged through the follow-up water paths.

### Embodiment II

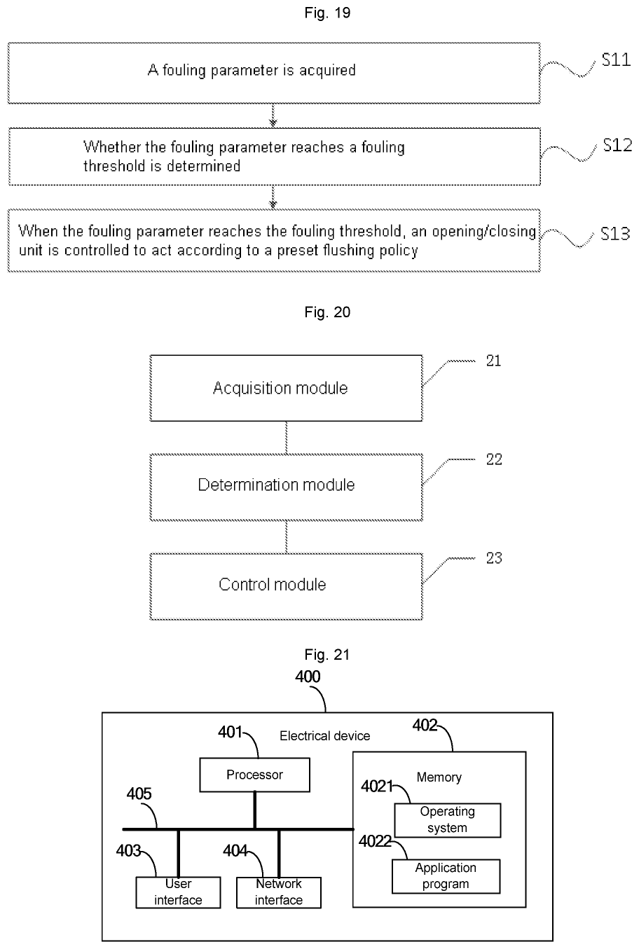

In combination with FIG. 19, some embodiments provide a flushing control method, which is applied to a water purification device, and can particularly be applied to a water purification device with an integrated valve. In combination with FIG. 1, the flushing control method includes the following steps.

At S11, a fouling parameter is acquired.

By using the water purification device as an example, due to impurities in water, a filter element is clogged to a certain extent after being used for a long time, and the fouling parameter is configured to represent a clogged state of the filter element. When the filter element is clogged to a certain extent, the filter element needs to be cleaned, so as to guarantee a normal filtration effect of the filter element. The fouling parameter can include a current water outlet flow value or a current water outlet pressure value. The current water outlet flow value can be acquired by a flow detection apparatus. In some embodiments, the flow detection apparatus can be a flowmeter or a flow sensor. The flowmeter or the flow sensor can be disposed on a water outlet pipeline. The current water outlet pressure value can be acquired by a pressure detection apparatus. In some embodiments, the pressure detection apparatus can be a pressure gage or a pressure sensor. The pressure gage or the pressure sensor can be disposed on the water outlet pipeline.

At S12, whether the fouling parameter reaches a fouling threshold is determined.

The fouling threshold can be a preset value, and is configured to represent a critical value at which the filter element has been clogged to a point where the filter element needs to be flushed. By using the water purification device as an example, when the fouling parameter is the current water outlet flow value, the fouling threshold can be set to a maximum flow value (e.g., 4.31/min) through a water outlet pipeline when flushing is required, which can be determined by those skilled in the art according to actual requirements. When the fouling parameter is the current water outlet pressure value, the fouling threshold can be set to a maximum pressure value through the water outlet pipeline when flushing is required, which can be determined by those skilled in the art according to actual requirements. After the fouling parameter is obtained, the fouling parameter is compared with the fouling threshold, so as to determine a relationship between the fouling parameter and the fouling threshold.

At S13, when the fouling parameter reaches the fouling threshold, an opening/closing unit is controlled to act according to a preset flushing policy.

When the fouling parameter reaches the fouling threshold, a state that the filter element has been clogged to the point where the filter element needs to be flushed can be determined, such that a flushing policy needs to be executed to guarantee the normal use of the filter element at follow-up phases. In some embodiments, when the fouling parameter reaches the fouling threshold, the filter element can be flushed according to the preset flushing policy by controlling the action of an opening/closing unit.

The opening/closing unit can be in various forms of a valve assembly, an integrated valve, a pipeline clamp, etc. The opening/closing unit is configured to control an opening/closing state of a water inlet pipeline and/or a water outlet pipeline.

According to the flushing control method provided in some embodiments, by means of acquiring the fouling parameter, determining whether the fouling parameter reaches the fouling threshold, and controlling the opening/closing unit to act according to the preset flushing policy after the fouling parameter reaches the fouling threshold, execution of the flushing policy can be determined according to actual clogging situations of the filter element, the timeliness of the execution of the flushing policy is guaranteed, and situations of early flushing or delayed flushing are avoided, such that the accuracy of the execution of the flushing policy is improved, and a water-saving effect is achieved on the basis of meeting the maximum use time of the filter element.

In some embodiments, before S13, the flushing control method further includes the following operations.

A filter element form is acquired, and a flushing mode is determined based on the filter element form.

When the filter element is a single independent filter element, it is determined that the flushing mode is intermittent.

When the filter element is a composite filter element or a plurality of independent filter elements, it is determined that the flushing mode is alternate.

In some embodiments, the filter element form may be the single independent filter element, may be the composite filter element, and may also be the plurality of independent filter elements.

When the single independent filter element is used, since the filter element is only provided with a water inlet and a water outlet, in a water-producing phase, raw water enters from the water inlet and flows out from the water outlet; in a flushing phase, the raw water or purified water enters from the water outlet and flows out from the water inlet, such that the backward flushing of the single independent filter element is realized; and in this case, the intermittent flushing mode can be used for the single independent filter element only by controlling the opening and closing of a valve.

When the composite filter element is used, one composite filter element is provided with at least two filter elements connected in parallel. Herein, to simplify the description, for example, the composite filter element is provided with two filter elements connected in parallel. Since the two filter elements both are provided with water inlets and water outlets, in the water-producing phase, the raw water can enter from the water inlets of the two filter elements, respectively, and is discharged from the water outlets of the two filter elements, respectively; and in the flushing phase, the raw water can enter from the water inlet of the first filter element, is filtered by the first filter element, and is then discharged by the water outlet of the first filter element, and the purified water discharged by the water outlet of the first filter element enters the inside of the second filter element via the water outlet of the second filter element, and backward flushes the second filter element from the inside of the second filter element outwards, such that waste water after flushing is discharged from the water inlet of the second filter element, so as to achieved an effect of flushing the second filter element with the purified water produced by the first filter element. Otherwise, an effect of flushing the first filter element with the purified water produced by the second filter element can also be achieved, and a specific process is not described herein again. Therefore, when the filter element form is the composite filter element, the alternate flushing mode can be used.

When the filter element is the plurality of independent filter elements, flow directions of water paths in the filter elements are the same as that using the composite filter element, such that details are not described herein again. Therefore, when the filter element is the composite filter element or the plurality of independent filter elements, it can be determined that the flushing mode is alternate, such that a flushing effect is improved with the produced purified water, so as to guarantee the cleanliness of flushing.

In some embodiments, when the filter element is the composite filter element or the plurality of independent filter elements, after it is determined that the flushing mode is alternate, the flushing control method further includes: acquiring a current water inlet pressure value.

Flushing time Tₜₒₜₐₗ is determined based on the current water inlet pressure value and a correspondence relationship between the current water inlet pressure value and flushing time.

Determination of the flushing time Tₜₒₜₐₗ needs to be determined based on the acquired current water inlet pressure value and the correspondence relationship between the current water inlet pressure value and the flushing time. When the correspondence relationship between the current water inlet pressure value and the flushing time can be measured before leaving the factory, a flow sensor is mounted on the water path; the number of flow pulses under different water inlet pressures is recorded through experimental testing; and the water inlet pressure and the number of flow pulses are saved by a controller. When the current water inlet pressure value needs to be acquired, the number of flow pulses detected is transmitted to the controller, and the controller matches a detected value and a recorded value, so as to find the corresponding water inlet pressure.

| Water inlet pressure value | Number of flow pulses |
|---|---|
| P1 | Q1 setting range value |
| P2 | Q2 setting range value |
| P3 | Q3 setting range value |

Q1 > Q2 > Q3 when pressure P1 > P2 > P3

Different water inlet pressure values P correspond to different flushing times T, and the higher the pressure, the shorter the flushing time. When the water inlet pressure value P1 is detected, the corresponding filter element flushing time matched by a program is T1; when the water inlet pressure value P2 is detected, the corresponding filter element flushing time matched by the program is T2; and when the water inlet pressure value P3 is detected, the corresponding filter element flushing time matched by the program is T3.

| Water inlet pressure value | Flushing time |
|---|---|
| P1 | T1 |
| P2 | T2 |
| P3 | T3 |

Flushing time T1 < T2 < T3 when pressure P1 > P2 > P3

Further, in order to improve the detection accuracy of the water inlet pressure value, through multiple detection recording data in the morning, noon, and evening, when the plurality of detected values are all within a set range value, the controller matches the detected value and the recorded value, so as to determine the water inlet pressure value.

In some embodiments, the opening/closing unit includes an integrated valve; and S13 includes the following operations.

An integrated valve action is adjusted to a first flushing state, and the first flushing state is stayed for a time Tₜₒₜₐₗ/2n.

The integrated valve action is adjusted to a second flushing state, and the second flushing state is stayed for the time Tₜₒₜₐₗ/2n.

Cycles of the first flushing state and the second flushing state are repeated for a total of n times.

The integrated valve action is adjusted to an initial state.

In some embodiments, the opening/closing unit can be the integrated valve; a motor is disposed on the integrated valve; and the motor drives a valve core to rotate, so as to adjust an opening/closing state of the integrated valve. For example, in the initial state, an angle of a motor shaft is at 0°, and in this case, the raw water enters the water inlets of the two filter elements, respectively, and is discharged from the water outlets of the two filter elements, respectively. When it is determined that the fouling parameter reaches the fouling threshold, the integrated valve acts to a first flushing state, for example, a signal is received by the controller, the controller transmits the signal to the motor, the motor shaft is controlled to rotate from 0° to a first angle value (e.g., +5°), and in this case, the raw water can enter from the water inlet of the first filter element, such that the waste water after flushing is discharged from the water inlet of the second filter element, so as to achieved the effect of flushing the second filter element with the purified water produced by the first filter element, and the state is stayed for a time Tₜₒₜₐₗ/2n (e.g., 30 seconds). After the maintenance time of the first flushing state ends, the integrated valve acts to a second flushing state, for example, the motor shaft rotates from the first angle value (e.g., +5°) to a second angle value (−5°), and in this case, the raw water can enter from the water inlet of the second filter element, such that the waste water after flushing is discharged from the water inlet of the first filter element, so as to achieved the effect of flushing the first filter element with the purified water produced by the second filter element, and the state is stayed for the time Tₜₒₜₐₗ/2n (e.g., 30 seconds). After the first flushing state and the second flushing state are completed once, a cycle is recorded, and the cycles of the first flushing state and the second flushing state are repeated for a total of n times (e.g., 5 times), so as to complete flushing. Therefore, the integrated valve is reset, and the integrated valve action is adjusted to the initial state (for example, the angle of the motor shaft is 0°). During the entire flushing process, the flushing time is Tₜₒₜₐₗ (e.g., 5 minutes).

### Embodiment III

In combination with FIG. 20, some embodiments provide a flushing control apparatus, which includes an acquisition module, a determination module, and a control module.

The acquisition module 21 is configured to acquire a fouling parameter.

The determination module 22 is configured to determine whether the fouling parameter reaches a fouling threshold.

The control module 23 is configured to, when the fouling parameter reaches the fouling threshold, control an opening/closing unit to act according to a preset flushing policy.

In some embodiments, the acquisition module includes at least one of a flow detection module and a pressure detection module.

### Embodiment IV

In combination with FIG. 21, some embodiments provide an electrical device, which includes a processor and a memory.

The processor is configured to execute a flushing control program stored in the memory, so as to implement the flushing control method described above.

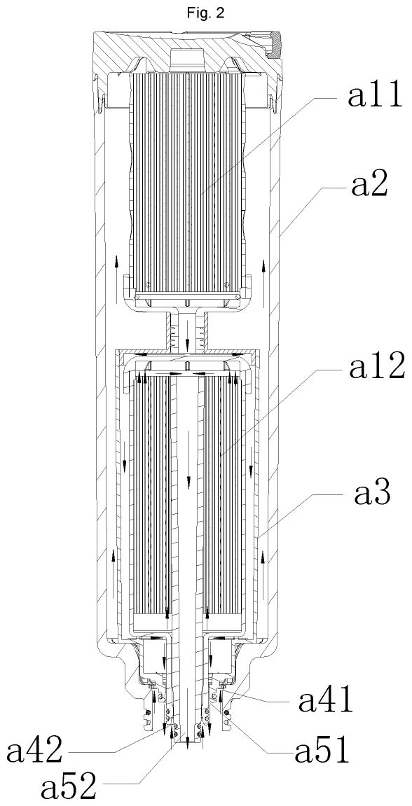

The electrical device 400 includes at least one processor 401, a memory 402, at least one network interface 404, and other user interfaces 403. Each assembly in the electrical device 400 is coupled together by means of a bus system 405. It is understandable that, the bus system 405 is configured to achieve connection communication between these assemblies. In addition to including a data bus, the bus system 405 further includes a power bus, a control bus, and a state signal bus. However, for the sake of clarity, the various buses are labeled as the bus system 405 in FIG. 2.

The user interface 403 may include a display, a keyboard or a clicking device (such as a mouse and a trackball), a touch panel or a touch screen, and the like.

It is to be understood that the memory 402 in some embodiments may be a volatile memory or a non-volatile memory, or may include both the volatile and non-volatile memories. The non-volatile memory may be an ROM, a PROM, an Erasable PROM (EPROM), an EEPROM or a flash memory. The volatile memory may be an RAM, and is used as an external high-speed cache. It is exemplarily but unlimitedly described that RAMs in various forms may be adopted, such as a Static RAM (SRAM), a Dynamic RAM (DRAM), a Synchronous DRAM (SDRAM), a Double Data Rate SDRAM (DDR SDRAM), an Enhanced SDRAM (ESDRAM), a Synch link DRAM (SLDRAM) and a Direct Rambus RAM (DR RAM). The memory 402 described herein is intended to include, but not limited to, memories of these and any other proper types.

In some implementations, the memory 402 stores elements, executable units or data structures, or subsets thereof, or extension sets thereof, as follows: an operating system 4021 and an application program 4022.

The operating system 4021 includes various system programs, such as a framework layer, a core library layer, a driver layer, etc., which are configured to implement various basic services and process tasks based on hardware. The application program 4022 includes various application programs, such as a media player, a browser, etc., which are configured to implement various application services. A program for implementing the method of this embodiment may be included in the application program 4022.

In some embodiments, by calling a program or instruction stored in the memory 402, which can be a program or instruction stored in the application program 4022, the processor 401 is configured to execute method steps provided in each method embodiment, for example, including: acquiring a fouling parameter; determining whether the fouling parameter reaches a fouling threshold; and when the fouling parameter reaches the fouling threshold, controlling an opening/closing unit to act according to a preset flushing policy.

In some embodiments, a filter element form is acquired, and a flushing mode is determined based on the filter element form; when the filter element is a single independent filter element, it is determined that the flushing mode is intermittent; and when the filter element is a composite filter element or a plurality of independent filter elements, it is determined that the flushing mode is alternate.

In some embodiments, a current water inlet pressure value is acquired; and flushing time Tₜₒₜₐₗ is determined based on the current water inlet pressure value and a correspondence relationship between the current water inlet pressure value and flushing time.

In some embodiments, an integrated valve action is adjusted to a first flushing state, and staying the state for a time Tₜₒₜₐₗ/2n; the integrated valve action is adjusted to a second flushing state, and staying the state for the time Tₜₒₜₐₗ/2n; cycles of the first flushing state and the second flushing state are repeated for a total of n times; and the integrated valve action is adjusted to an initial state.

The method disclosed in some embodiments can be applied to the processor 401, or implemented by the processor 401. The processor 401 can be an integrated circuit chip and has a signal processing capacity. During implementation, each step of the method can be completed by an integrated logical circuit of hardware in the processor 401 or an instruction in a software form. The above processor 401 may be a general processor, a Digital Signal Processor (DSP), an Application Specific Integrated Circuit (ASIC), a Field-Programmable Gate Array (FPGA) or other programmable logic devices, discrete gate or transistor logic devices, and discrete hardware components. Each method, step and logical block diagram disclosed in some embodiments can be implemented or executed. The general processors can be microprocessors or the processor can also be any conventional processors. In combination with the method disclosed in some embodiments, the steps can be directly implemented by a hardware processor, or can be performed by a combination of hardware and software units in the decoding processor. The software unit can be located in a mature storage medium in the field such as a Random Access Memory (RAM), a flash memory, a Read-Only Memory (ROM), a Programmable ROM (PROM) or Electrically Erasable PROM (EEPROM), and a register. The storage medium is located in a memory 402, and the processor 401 reads information in the memory 402, and completes the steps of the method in combination with hardware.

It is understandable that, these embodiments described herein can be implemented with hardware, software, firmware, middleware, microcode, or a combination thereof. For hardware implementation, the processing unit may be implemented in one or more Application Specific Integrated Circuits (ASICs), a Digital Signal Processor (DSP), a Digital Signal Processing Device (DSPD), a Programmable Logic Device (PLD), a Field Programmable Gate Array (FPGA), a general processor, a controller, a microcontroller, a microprocessor, or other electronic units configured to execute functions described in the present disclosure or a combination thereof.

For software implementation, the technologies described herein may be implemented by executing functional units described herein. A software code may be stored in the memory and be executed by the processor. The memory may be implemented in or outside the processor.

The electrical device provided in some embodiments can be the electrical device shown in FIG. 20, and can execute all steps of the flushing control method in FIG. 19, such that the technical effects of the flushing control method shown in FIG. 19 are implemented. Details are described with reference to related descriptions in FIG. 19. For the sake of brevity of description, details are not described herein again.

Some embodiments provide a storage medium. The storage medium stores one or more programs; the one or more programs are executable by one or more processors, so as to implement the flushing control method described above.

The storage medium includes a volatile memory, such as an RAM; the memory may also include a non-volatile memory, such as an ROM, a flash memory, a hard disk, or a solid state disk; and the memory may also include a combination of the above types of memory.

The one or more programs in the storage medium are executable by one or more processors, so as to implement the flushing control method executed on a control apparatus side.

The processor is configured to execute a flushing control program stored in the memory, so as to implement the following steps of the flushing control method executed on the control apparatus side.

A fouling parameter is acquired; whether the fouling parameter reaches a fouling threshold is determined; and when the fouling parameter reaches the fouling threshold, an opening/closing unit is controlled to act according to a preset flushing policy. The fouling parameter includes a current water outlet flow value or a current water outlet pressure value.

In some embodiments, a filter element form is acquired, and a flushing mode is determined based on the filter element form; when the filter element is a single independent filter element, it is determined that the flushing mode is intermittent; and when the filter element is a composite filter element or a plurality of independent filter elements, it is determined that the flushing mode is alternate.

In some embodiments, a current water inlet pressure value is acquired; and flushing time Tₜₒₜₐₗ is determined based on the current water inlet pressure value and a correspondence relationship between the current water inlet pressure value and flushing time.

In some embodiments, the opening/closing unit includes an integrated valve; an integrated valve action is adjusted to a first flushing state, and staying the state for a time Tₜₒₜₐₗ/2n; the integrated valve action is adjusted to a second flushing state, and staying the state for the time Tₜₒₜₐₗ/2n; cycles of the first flushing state and the second flushing state are repeated for a total of n times; and the integrated valve action is adjusted to an initial state.

Those skilled in the art should further realize that the units and algorithmic steps of the various examples described in combination with the embodiments disclosed herein are capable of being implemented in electronic hardware, computer software, or a combination of electronic hardware and computer software. In order to clearly illustrate the interchangeability of hardware and software, the composition and the steps of the examples have been described in the above description in general terms according to functions. Whether these functions are executed in a hardware or software manner depends on specific applications and design constraints of the technical solutions. Those skilled in the art may realize the described functions for each specific application by use of different methods, but such implementation shall fall within the scope of this application.

The steps of the method or algorithm described in combination with the embodiments disclosed herein may be implemented with the hardware, a software module executed by the processor, or a combination of the hardware and the software module. The software module may be provided in the RAM, the memory, the ROM, the electrically programmable ROM, the electrically erasable programmable ROM, the register, the hard disk, a removable disk, a CD-ROM, or any other form of storage media known in the technical field.

### Embodiment V

This embodiment further provides a water purification system, which includes the water purification device described above, a post-processing assembly f3, a water pump f32, a water inlet pipeline d4, and a purified water outlet pipeline d5. The water pump f32 is disposed on a front end of the post-processing assembly f3. The water inlet pipeline d4 communicates with a raw water inlet b11 of the water purification device. The purified water outlet pipeline d5 communicates with a purified water outlet of the water purification device. The water purification device is disposed on a front end of the water pump f32, a water inlet of the water pump f32 communicates with the purified water outlet pipeline d5, and a water outlet of the water pump communicates with the post-processing assembly f3, so as to transport purified water filtered by the water purification device into the post-processing assembly f3.

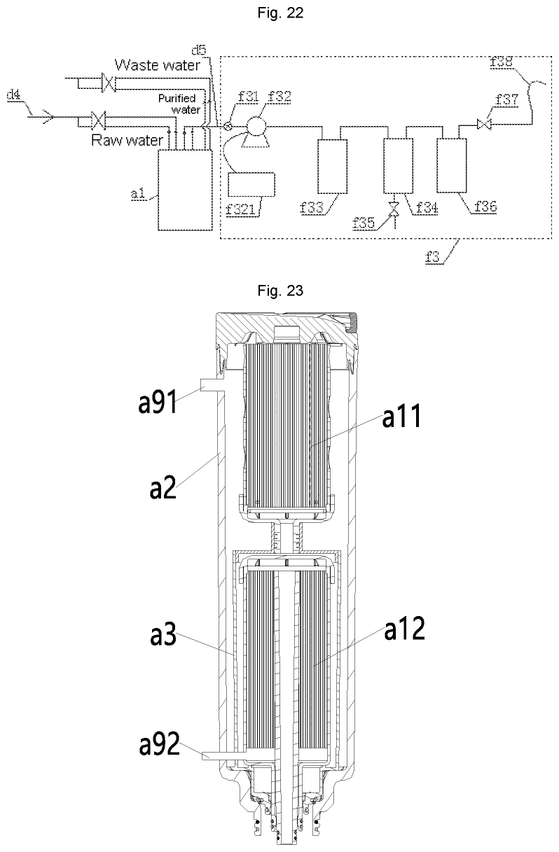

The water purification device provided in some embodiments include the post-processing assembly f3; the post-processing assembly f3 communicates with the purified water outlet end; and the conduction of the purified water outlet end and the post-processing assembly f3 is controlled by disposing a purified water outlet control valve on the purified water outlet end. In combination with FIG. 22, the figure schematically shows that the post-processing assembly f3 includes the water pump f32, a pre-processing unit f33, a reverse osmosis filter element f34, a post-processing filter element f36, a pressure switch f37, and a water faucet f38.

In the present disclosure, by means of adding the ultrafiltration composite filter element a1, and disposing the ultrafiltration composite filter element on a front end of the post-processing assembly f3 as a pre-filter element, the ultrafiltration composite filter element can achieve a relatively-refined filtration function at an early stage of water production. In the water purification system of the present disclosure, by means of adding the ultrafiltration composite filter element a1, and disposing the ultrafiltration composite filter element on the front end of the post-processing assembly f3 as the pre-filter element, the ultrafiltration composite filter element has higher filtration accuracy than a common pre-filter element, such that the last several levels of the filter elements can be protected, and the service life of the filter elements subsequently disposed is prolonged.

The water pump f32 is connected with a water pump control module f321; and the water pump control module f321 can control the specific work of the water pump f32. The water pump control module f321 can be a controller.

In some embodiments, the post-processing assembly f3 includes the reverse osmosis filter element f34; and the reverse osmosis filter element f34 is a reverse osmosis membrane (RO membrane). The reverse osmosis filter element f34 is connected to a reverse osmosis water outlet control valve f35; and in a state where the reverse osmosis filter element f34 performs flushing and pressure relief, the reverse osmosis water outlet control valve f35 is fully opened.

In some embodiments, the pre-processing unit f33 may also be disposed before the reverse osmosis filter element f34, such that water is pre-processed before entering the reverse osmosis filter element f34. Further, the reverse osmosis filter element f34 may further be provided with the post-processing filter element f36, such that filtration accuracy is further improved.

In some embodiments, a pipeline of the post-processing assembly f3 is provided with the pressure switch f37. In some embodiments, through the arrangement of the pressure switch f37, the pressure of the water purification system can be flexibly adjusted.

In some embodiments, the filtered water is conveniently discharged by the water faucet f38.

Various technical features of the above embodiments may be combined arbitrarily. For brevity of description, description is not made to all possible combinations of the various technical features of the above embodiments are described. However, all the combinations of these technical features should be considered to fall within the scope of disclosure contained in the specification as long as there is no contradiction between the combinations of those technical features.

The above embodiments merely illustrate several implementations of the present disclosure, which are specifically described in detail, but are not to be construed as limiting the scope of the present patent for the present disclosure. It should be pointed out that, those of ordinary skill in the art can also make some modifications and improvements without departing from the concept of the present disclosure, and these modifications and improvements all fall within the scope of protection of the present disclosure. Accordingly, the scope of the patent of the present disclosure should be subject to the appended claims.

1. A water purification device, comprising:
an ultrafiltration composite filter element, provided with a plurality of filter elements connected in parallel, wherein each of the plurality of filter elements is provided with at least one water inlet and at least one purified water outlet, and purified water outlets of the plurality of filter elements communicate with each other; and
an opening/closing unit, communicating with water inlets of the plurality of filter elements, wherein
the opening/closing unit, when in a water-producing state, is configured to introduce raw water into the plurality of filter elements from the water inlets, and discharge purified water by the purified water outlets after filtration of the plurality of filter elements; and the opening/closing unit is further configured to switch from the water-producing state to a flushing state, and, when in the flushing state, introduce the raw water into the plurality of filter elements from water inlet(s) of one or more filter elements in the plurality of filter elements; and in this case, the purified water outlets of the plurality of filter elements are closed and communicate with each other, an other one or more filter elements in the plurality of filter elements are flushed with purified water, and then waste water is discharged by water inlet(s) of the other one or more filter elements or a drainage outlet.

2. The water purification device as claimed in claim 1, wherein the ultrafiltration composite filter element comprises a first filter element and a second filter element, which are disposed in parallel; and
the flushing state of the opening/closing unit comprises a first filter element backward flushing second filter element state and a second filter element backward flushing first filter element state.

3. The water purification device as claimed in claim 2, comprising a raw water inlet and a waste water outlet;
when the opening/closing unit is in the water-producing state, the opening/closing unit is configured to simultaneously communicate the raw water inlet with a water inlet of the first filter element and a water inlet of the second filter element;
when the opening/closing unit is in the first filter element backward flushing second filter element state, the opening/closing unit is configured to communicate the raw water inlet with the water inlet of the first filter element, and communicate the waste water outlet with the water inlet of the second filter element or the drainage outlet; and
when the opening/closing unit is in the second filter element backward flushing first filter element state, the opening/closing unit is configured to communicate the raw water inlet with the water inlet of the second filter element, and communicate the waste water outlet with the water inlet of the first filter element or the drainage outlet.

4. The water purification device as claimed in claim 3, wherein the first filter element is provided with a first ultrafiltration membrane, and provided with a first water inlet and a first purified water outlet; the first water inlet communicates with an inner side or an outer side of the first ultrafiltration membrane, and the first purified water outlet communicates with the outer side or the inner side of the first ultrafiltration membrane; the first water inlet and the first purified water outlet respectively communicate with different sides of the inner side and the outer side of the first ultrafiltration membrane;
the second filter element is provided with a second ultrafiltration membrane, and provided with a second water inlet and a second purified water outlet; the second water inlet communicates with an inner side or an outer side of the second ultrafiltration membrane, and the second purified water outlet communicates with the outer side or the inner side of the second ultrafiltration membrane; the second water inlet and the second purified water outlet respectively communicate with different sides of the inner side and the outer side of the second ultrafiltration membrane.

5. The water purification device as claimed in claim 4, wherein when the opening/closing unit is in the water-producing state, the raw water inlet communicates with the first water inlet and the second water inlet, such that the raw water flows through the first ultrafiltration membrane or the second ultrafiltration membrane and then is discharged by the first purified water outlet and the second purified water outlet;
when the opening/closing unit is in the first filter element backward flushing second filter element state, the raw water inlet communicates with the first water inlet such that the raw water flows through the first ultrafiltration membrane, then is discharged by the first purified water outlet, enters from the second purified water outlet, and then is discharged by the second water inlet after flowing through the second ultrafiltration membrane; and
when the opening/closing unit is in the second filter element backward flushing first filter element state, the raw water inlet communicates with the second water inlet such that the raw water flows through the second ultrafiltration membrane, then is discharged by the second purified water outlet, enters from the first purified water outlet, and then is discharged by the first water inlet after flowing through the first ultrafiltration membrane.

6. The water purification device as claimed in claim 5, wherein the water purification device further comprises a filter element base body, which is configured to communicate the ultrafiltration composite filter element with an external pipe, wherein the filter element base body is provided with N channels, wherein N=M, and M is a sum of a number of the water inlets and the purified water outlets.

7. The water purification device as claimed in claim 2, wherein the first filter element and the second filter element are disposed at upper and lower parts or inner and outer layers.

8. The water purification device as claimed in claim 1, wherein the opening/closing unit comprises an integrated valve; and the integrated valve comprises:
a valve body, provided with a valve body inlet, at least three cavities, and at least three outlets, respectively, wherein the at least three cavities comprise a first valve body cavity, a second valve body cavity, and a third valve body cavity, and the at least three outlets comprise a first outlet, a second outlet, and a third outlet;
a valve core, disposed on an upper end surface of the valve body and provided with a valve core inlet and at least three valve core outlets, wherein a first valve core outlet of the valve core communicates with the first valve body cavity, a second valve core outlet of the valve core communicates with the second valve body cavity, a third valve core outlet of the valve core communicates with the third valve body cavity of the valve body, and the valve core inlet communicates with the valve body inlet; and
a rotary disc, provided with a plurality of flow paths, respectively, wherein through rotation of the rotary disc, a corresponding flow path in the plurality of flow paths communicates with the valve core inlet and a valve core outlet of the at least three valve core outlets, so as to switch each of the plurality of flow paths.

9. The water purification device as claimed in claim 8, wherein the first valve body cavity, the second valve body cavity, and the third valve body cavity are spaced apart from each other;
the first valve body cavity sequentially communicates with a first outlet/inlet pipeline and a first water inlet through the first outlet;
the second valve body cavity sequentially communicates with a second outlet/inlet pipeline and a second water inlet through the second outlet;
the third valve body cavity communicates with a waste water outlet through the third outlet;
one of the first valve body cavity and the second valve body cavity is configured to selectively communicate with the third valve body cavity; and
at least one of the first valve body cavity and the second valve body cavity is configured to selectively communicate with the valve body inlet.

10. The water purification device according to claim 9, wherein the rotary disc comprises a first flow path and a second flow path; when the integrated valve is in a first position, the first flow path and the second flow path are disposed in parallel and connected to an outside.

11. The water purification device as claimed in claim 10, wherein the first flow path communicates with the valve core inlet and the first valve core outlet, and the second flow path communicates with the valve core inlet and the second valve core outlet.

12. The water purification device as claimed in claim 10, wherein the rotary disc further comprises a third flow path and a fourth flow path; the third flow path communicates with the valve core inlet and the first valve core outlet, and the fourth flow path communicates with the second valve core outlet and the third valve core outlet; or
the third flow path communicates with the valve core inlet and the second valve core outlet, and the fourth flow path communicates with the first valve core outlet and the third valve core outlet.

13. The water purification device as claimed in claim 12, wherein when the integrated valve is in the first position, the rotary disc rotates to the first position, the valve core inlet of the valve core communicates with the first valve core outlet through the first flow path of the rotary disc, and the valve core inlet communicates with the second valve core outlet through the second flow path; the first valve core outlet communicates with the first valve body cavity of the valve body, and then communicates with the first water inlet through the first outlet/inlet pipeline; the second valve core outlet communicates with the second valve body cavity of the valve body, and then communicates with the second water inlet through the second outlet/inlet pipeline;
when the integrated valve is in a second position, the rotary disc rotates to the second position, the valve core inlet communicates with the first valve core outlet through the third flow path of the rotary disc, the second valve core outlet communicates with the third valve core outlet through the fourth flow path, and in this case, the first valve core outlet communicates with the first valve body cavity of the valve body, then communicates with the first filter element sequentially via the first outlet/inlet pipeline and the first water inlet, then communicates with the second valve body cavity via the second water inlet or the drainage outlet and the second outlet/inlet pipeline, and then communicates with the waste water outlet through the second valve core outlet via the fourth flow path of the rotary disc, the third valve core outlet, and the third valve body cavity of the valve body; and
when the integrated valve is in a third position, the rotary disc-rotates to the third position, the valve core inlet communicates with the second valve core outlet through the third flow path of the rotary disc, the first valve core outlet communicates with the third valve core outlet through the fourth flow path, and in this case, the second valve core outlet communicates with the second valve body cavity of the valve body, then communicates with the second filter element sequentially via the second outlet/inlet pipeline and the second water inlet, then communicates with the first valve body cavity via the first water inlet or the drainage outlet and the first outlet/inlet pipeline, and then communicates with the waste water outlet through the first valve core outlet via the fourth flow path of the rotary disc, the third valve core outlet, and the third valve body cavity of the valve body; or wherein the fourth flow path is constructed as a kidney-shaped groove; and when the integrated valve is in a second position or a third position, the kidney-shaped groove rotates to communicate with two adjacent valve core outlets of the valve core.

14. (canceled)

15. The water purification device as claimed in claim 4, wherein the drainage outlet comprises a first drainage outlet and a second drainage outlet; the first drainage outlet communicates with the outer side or the inner side of the first ultrafiltration membrane; the second drainage outlet communicates with the outer side or the inner side of the second ultrafiltration membrane;
in the water-producing state, the first drainage outlet and the second drainage outlet are closed at the same time;
in the first filter element backward flushing second filter element state, the first drainage outlet is closed, and the second drainage outlet is selectively opened; and
in the second filter element backward flushing first filter element state, the second drainage outlet is closed, and the first drainage outlet is selectively opened.

16. A flushing control method, applied to the water purification device as claimed in claim 1, and comprising:
acquiring a fouling parameter;
determining whether the fouling parameter reaches a fouling threshold; and
when the fouling parameter reaches the fouling threshold, controlling an opening/closing unit to act according to a preset flushing policy.

17. The flushing control method as claimed in claim 16, wherein the fouling parameter comprises a current water outlet flow value or a current water outlet pressure value; wherein the flushing control method further comprises:
acquiring a current water inlet pressure value; and
determining a flushing time Ttotal based on the current water inlet pressure value and a correspondence relationship between the current water inlet pressure value and a flushing time.

18. (canceled)

19. The flushing control method as claimed in claim 17, wherein the opening/closing unit comprises an integrated valve; and when the fouling parameter reaches the fouling threshold, controlling the opening/closing unit to act according to the preset flushing policy comprises:
adjusting the integrated valve action to a first flushing state, and staying the first flushing state for a time Tₜₒₜₐₗ/2n;
adjusting the integrated valve action to a second flushing state, and staying the second flushing state for the time Tₜₒₜₐₗ/2n;
repeating cycles of the first flushing state and the second flushing state for a total of n times; and
adjusting the integrated valve action to an initial state.

20. (canceled)

21. (canceled)

22. An electrical device, comprising a processor and a memory, wherein the processor is configured to execute a flushing control program stored in the memory, so as to implement the flushing control method as claimed in claim 16.

23. A storage medium, storing one or more programs, wherein the one or more programs are executable by one or more processors, so as to implement the flushing control method as claimed in claim 16.

24. A water purification system, comprising the water purification device as claimed in claim 1, and further comprising:
a post-processing assembly;
a water pump, disposed on a front end of the post-processing assembly;
a water inlet pipeline, communicating with a raw water inlet of the water purification device; and
a purified water outlet pipeline, communicating with a purified water outlet of the water purification device, wherein
the water purification device is disposed on a front end of the water pump, a water inlet of the water pump communicates with the purified water outlet pipeline, and a water outlet of the water pump communicates with the post-processing assembly, so as to transport purified water filtered by the water purification device into the post-processing assembly.
